(19) United States
(12) Patent Application Publication
(10) Pub. No.: US 2004/0252287 A1
(43) Pub. Date: Dec. 16, 2004

(54) Reaction frame assembly that functions as a reaction mass

(76) Inventors: Michael Binnard, Belmont, CA (US); Douglas C. Watson, Campbell, CA (US)

Correspondence Address: The Law Office of Steven G. Roeder, 5560 Chelsea Avenue, La Jolla, CA, 92037, US

(21) Appl. No.: 10/459,817

(22) Filed: Jun. 11, 2003

(51) Int. Cl. G03B 27/42

(52) U.S. Cl. 355/53; 355/72; 355/75; 310/10; 310/12; 318/640; 378/34

(57) ABSTRACT

A stage assembly (224) for moving and positioning a device (200) relative to a mounting base (232) includes a stage base (202), a stage (206), a stage mover assembly (204), and a reaction frame assembly (230). The stage mover assembly (204) moves the stage (206) along an X axis, along a Y axis and about a Z axis. The reaction frame assembly (230) is coupled to the stage mover assembly (204) and reduces the magnitude of the reaction forces created by the stage mover assembly (204) that are transferred to the stage (206) and the mounting base (232). In one embodiment, the reaction frame assembly (230) includes a first mass assembly (256) and a first mass support assembly (258). In this embodiment, the first mass assembly (256) is coupled to the stage mover assembly (204), and the first mass support assembly (258) supports the first mass assembly (256) relative to the mounting base (232) and allows the first mass assembly (256) to move relative to the mounting base (232) along the Z axis. Additionally, the first mass support assembly (258) can include a first mass adjuster (286) that adjusts the position of the first mass assembly (256) relative to the mounting base (232) along the Z axis.

### FIELD OF THE INVENTION

The present invention is directed to a stage assembly that includes a reaction frame assembly for an exposure apparatus.

### BACKGROUND

Exposure apparatuses are commonly used to transfer images from a reticle onto a semiconductor wafer during semiconductor processing. A typical exposure apparatus includes an illumination source, a reticle stage assembly that retains a reticle, a lens assembly and a wafer stage assembly that retains a semiconductor wafer. The reticle stage assembly and the wafer stage assembly are supported above a mounting base with an apparatus frame.

In one embodiment, the wafer stage assembly includes a wafer stage base, a wafer stage that retains the wafer, and a wafer stage mover assembly that precisely positions the wafer stage and the wafer. Somewhat similarly, the reticle stage assembly includes a reticle stage base, a reticle stage that retains the reticle, and a reticle stage mover assembly that precisely positions the reticle stage and the reticle. The size of the images and the features within the images transferred onto the wafer from the reticle are extremely small. Accordingly, the precise relative positioning of the wafer and the reticle is critical to the manufacturing of high density, semiconductor wafers.

Unfortunately, the wafer stage mover assembly generates reaction forces that can vibrate the wafer stage base and the apparatus frame. The vibration influences the position of the wafer stage base, the wafer stage, and the wafer. Similarly, the reticle stage mover assembly generates reaction forces that can vibrate the reticle stage, base and the apparatus frame. The vibration influences the position of the reticle stage base, the reticle stage, and the reticle. As a result thereof, the vibration can cause an alignment error between the reticle and the wafer. This reduces the accuracy of positioning of the wafer relative to the reticle, or some other reference. As a result thereof, the accuracy of the exposure apparatus and the quality of the integrated circuits formed on the wafer can be compromised.

In light of the above, there is a need for a stage assembly that precisely positions a device. Further, there is a need for a stage assembly that minimizes the influence of the reaction forces of the stage mover assembly upon the position of the stage, the stage base, and the apparatus frame. Additionally, there is a need for a stage assembly having an improved reaction assembly. Moreover, there is a need for an exposure apparatus capable of manufacturing precision devices such as high density, semiconductor wafers.

### SUMMARY

The present invention is directed to a stage assembly that moves a device relative to a mounting base. The stage assembly includes a stage base, a stage, a stage mover assembly, and a reaction frame assembly. The stage retains the device. The stage mover assembly moves the stage relative to the stage base at least along a first axis and generates reaction forces along the first axis. The reaction frame assembly reduces the magnitude of the reaction forces along the first axis that are transferred to the stage base and the mounting base. As a result thereof, the stage assembly can more accurately position the device. Further, the stage assembly can be used in an exposure apparatus to manufacture high density, high quality semiconductor wafers.

In one embodiment, the reaction frame assembly includes a first mass assembly and a first mass support assembly. In this embodiment, the first mass assembly is coupled to the stage mover assembly, and the first mass support assembly supports the first mass assembly relative to the mounting base and allows the first mass assembly to move relative to the mounting base along the first axis. Additionally, the first mass support assembly can include a first mass adjuster that adjusts the position of the first mass assembly relative to the mounting base along a third axis.

In one embodiment, the stage mover assembly moves the stage about the third axis and generates reaction forces about the third axis. In this embodiment, the reaction frame assembly can reduce the magnitude of the reaction forces about the third axis that are transferred to the stage base and the mounting base. In another embodiment, the stage mover assembly also moves the stage along a second axis and generates reaction forces along the second axis. Further, the reaction frame assembly can reduce the magnitude of the reaction forces along the second axis that are transferred to the stage base and the mounting base. In this embodiment, the reaction frame assembly can include a second mass assembly and a second mass support assembly. The second mass assembly is coupled to the stage mover assembly, and the second mass support assembly supports the second mass assembly relative to the mounting base and allows the second mass assembly to move relative to the mounting base along the second axis. Additionally, the second mass support assembly can include a second mass adjuster that adjusts the position of the second mass assembly relative to the mounting base along the third axis.

In one embodiment, the stage mover assembly includes a base adjuster that supports the stage base relative to the mounting base and adjusts the position of the stage base relative to the mounting base.

As provided herein, the first mass assembly can include a first X mass and/or a second X mass that is spaced apart from the first X mass. Further, the second mass assembly can include a first Y mass, and/or a second Y mass that is spaced apart from the first Y mass.

Additionally, the reaction frame assembly can include a first trim mover assembly that adjusts the position of the first mass assembly along the X axis and/or a second trim mover assembly that adjusts the position of the second mass assembly along the Y axis.

The present invention is also directed to an exposure apparatus, a device made with the exposure apparatus, a wafer made with the exposure apparatus, a method for making a stage assembly, a method for making an exposure apparatus, a method for making a device and a method for manufacturing a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side illustration of an exposure apparatus having features of the present invention;

FIG. 2A is a perspective view of a first embodiment of a stage assembly having features of the present invention;

FIG. 2B is an exploded perspective view of the stage assembly of FIG. 2A;

FIG. 2C is a front view of the stage assembly of FIG. 2A;

FIG. 2D is a side view of the stage assembly of FIG. 2A;

FIG. 3 is a perspective view of another embodiment of a stage assembly having features of the present invention;

FIG. 4 is a perspective view of yet another embodiment of a stage assembly having features of the present invention;

FIG. 5 is a perspective view of still another embodiment of a stage assembly having features of the present invention;

FIG. 6 is a perspective view of another embodiment of a stage assembly having features of the present invention;

FIG. 7A is a perspective view of yet another embodiment of a stage assembly having features of the present invention;

FIG. 7B is a cut-away view taken on line 7B-7B of FIG. 7A;

FIG. 7C is a cut-away view taken on line 7C-7C of FIG. 7A;

FIG. 8A is a perspective view of still another embodiment of a stage assembly having features of the present invention;

FIG. 8B is a cut-away view taken on line 8B-8B of FIG. 8A;

FIG. 9A is a flow chart that outlines a process for manufacturing a device in accordance with the present invention; and

FIG. 9B is a flow chart that outlines device processing in more detail.

### DESCRIPTION

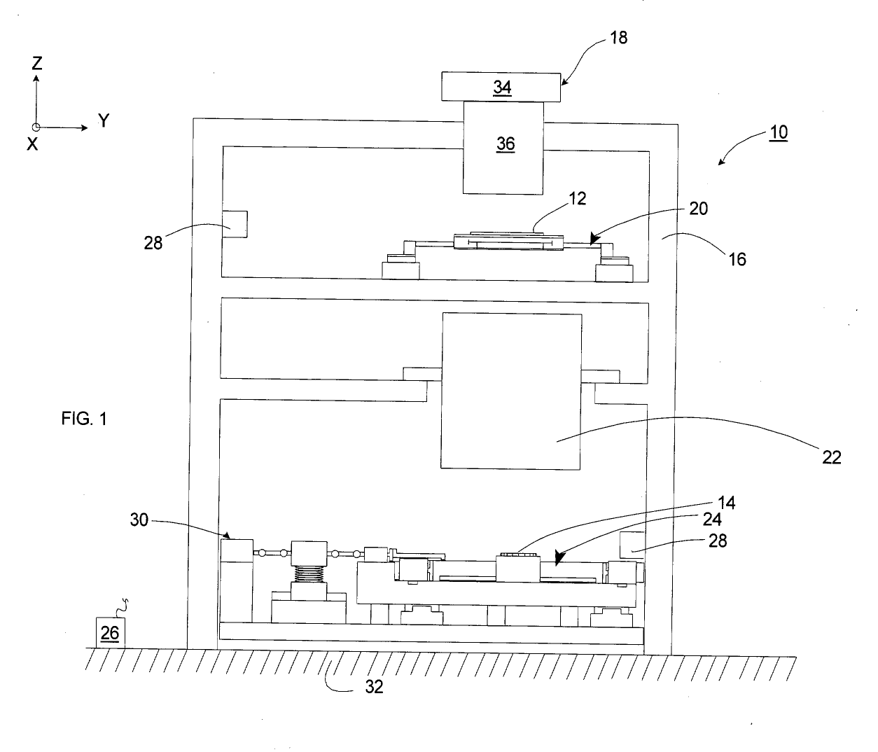

FIG. 1 is a schematic view that illustrates a precision assembly, namely an exposure apparatus 10. The exposure apparatus 10 is particularly useful as a lithographic device that transfers a pattern (not shown) of an integrated circuit from a reticle 12 onto a device, such as a semiconductor wafer 14. In FIG. 1, the exposure apparatus 10 includes an apparatus frame 16, an illumination system 18 (irradiation apparatus), a reticle stage assembly 20, an optical assembly 22 (lens assembly), a wafer stage assembly 24, a control system 26, and a measurement system 28. As described below, the wafer stage assembly 24 includes a reaction frame assembly 30 that transfers reaction forces away from the rest of the wafer stage assembly 24. The exposure apparatus 10 mounts to a mounting base 32, e.g., the ground, a base, or floor or some other supporting structure. The design of the components of the exposure apparatus 10 can be varied to suit the design requirements of the exposure apparatus 10.

A number of Figures include an orientation system that illustrates an X axis, a Y axis that is orthogonal to the X axis and a Z axis that is orthogonal to the X and Y axes. It should be noted that these axes are also referred to as the first, second and third axes.

There are a number of different types of lithographic devices. For example, the exposure apparatus 10 can be used as scanning type photolithography system that exposes the pattern from the reticle 12 onto the wafer 14 with the reticle 12 and the wafer 14 moving synchronously. In a scanning type lithographic device, the reticle 12 is moved perpendicularly to an optical axis of the optical assembly 22 by the reticle stage assembly 20 and the wafer 14 is moved perpendicularly to the optical axis of the optical assembly 22 by the wafer stage assembly 24. Scanning of the reticle 12 and the wafer 14 occurs while the reticle 12 and the wafer 14 are moving synchronously.

Alternatively, the exposure apparatus 10 can be a step-and-repeat type photolithography system that exposes the reticle 12 while the reticle 12 and the wafer 14 are stationary. In the step and repeat process, the wafer 14 is in a constant position relative to the reticle 12 and the optical assembly 22 during the exposure of an individual field. Subsequently, between consecutive exposure steps, the wafer 14 is consecutively moved with the wafer stage assembly 24 perpendicularly to the optical axis of the optical assembly 22 so that the next field of the wafer 14 is brought into position relative to the optical assembly 22 and the reticle 12 for exposure. Following this process, the images on the reticle 12 are sequentially exposed onto the fields of the wafer 14, and then the next field of the wafer 14 is brought into position relative to the optical assembly 22 and the reticle 12.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask to a substrate with the mask located close to the substrate without the use of a lens assembly.

The apparatus frame 16 is rigid and supports some of the components of the exposure apparatus 10. The apparatus frame 16 illustrated in FIG. 1 supports the optical assembly 22, the illumination system 18, and the reticle stage assembly 20 above the mounting base 32.

The illumination system 18 includes an illumination source 34 and an illumination optical assembly 36. The illumination source 34 emits a beam (irradiation) of light energy. The illumination optical assembly 36 guides the beam of light energy from the illumination source 34 to the optical assembly 22. The beam selectively illuminates different portions of the reticle 12 and exposes the semiconductor wafer 14. In FIG. 1, the illumination source 34 is illustrated as being supported above the reticle stage assembly 20. Typically, however, the illumination source 34 is secured to one of the sides of the apparatus frame 16 and the energy beam from the illumination source 34 is directed to the reticle 12 with the illumination optical assembly 36.

The illumination source 34 can be a g-line source (436 nm), an i-line source (365 nm), a KrF excimer laser (248 nm), an ArF excimer laser (193 nm) or a F₂ laser (157 nm). Alternatively, the illumination source 34 can generate charged particle beams such as an x-ray or an electron beam. For instance, in the case where an electron beam is used, thermionic emission type lanthanum hexaboride (LaB₆) or tantalum (Ta) can be used as a cathode for an electron gun. Furthermore, in the case where an electron beam is used, the structure could be such that either a mask is used or a pattern can be directly formed on a substrate without the use of a mask.

The optical assembly 22 projects and/or focuses the light passing through the reticle 12 to the wafer 14. Depending upon the design of the exposure apparatus 10, the optical assembly 22 can magnify or reduce the image illuminated on the reticle 12. The optical assembly 22 need not be limited to a reduction system. It could also be a 1× or magnification system.

When far ultra-violet rays such as the excimer laser is used, glass materials such as quartz and fluorite that transmit far ultra-violet rays can be used in the optical assembly 22. When the F₂ type laser or x-ray is used, the optical assembly 22 can be either catadioptric or refractive (the reticle can be a reflective type), and when an electron beam is used, electron optics should preferably consist of electron lenses and deflectors. The optical path for the electron beams should be in a vacuum.

Also, with an exposure apparatus 10 that employs vacuum ultra-violet radiation (VUV) of wavelength 200 nm or lower, use of the catadioptric type optical system can be considered. Examples of the catadioptric type of optical system include the disclosure Japan Patent Application Disclosure No.8-171054 published in the Official Gazette for Laid-Open Patent Applications and its counterpart U.S. Pat. No, 5,668,672, as well as Japan Patent Application Disclosure No.10-20195 and its counterpart U.S. Pat. No. 5,835,275. In these cases, the reflecting optical device can be a catadioptric optical system incorporating a beam splitter and concave mirror. Japan Patent Application Disclosure No.8-334695 published in the Official Gazette for Laid-Open Patent Applications and its counterpart U.S. Pat. No. 5,689,377 as well as Japan Patent Application Disclosure No.10-3039 and its counterpart U.S. Patent Application No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 20 holds and positions the reticle 12 relative to the optical assembly 22 and the wafer 14. Similarly, the wafer stage assembly 24 holds and positions the wafer 14 with respect to the projected image of the illuminated portions of the reticle 12. The wafer stage assembly 24 is described in more detail below.

Further, in photolithography systems, when linear motors (see U.S. Pat. Nos. 5,623,853 or 5,528,118) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically transferred to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically transferred to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The control system 26 receives information from the measurement system 28 and controls the stage mover assemblies 20, 24 to precisely position the reticle 12 and the wafer 14. Further, the control system 26 can be used to control and position portions of the reaction frame assembly 30.

The measurement system 28 monitors movement of the reticle 12 and the wafer 14 relative to the optical assembly 22 or some other reference. With this information, the control system 26 can control the reticle stage assembly 20 to precisely position the reticle 12 and the wafer stage assembly 24 to precisely position the wafer 14. Further, the measurement system 28 can monitor the movement and position of a portion of the reticle frame assembly 30. For example, the measurement system 28 can utilize multiple laser interferometers, encoders, and/or other measuring devices.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

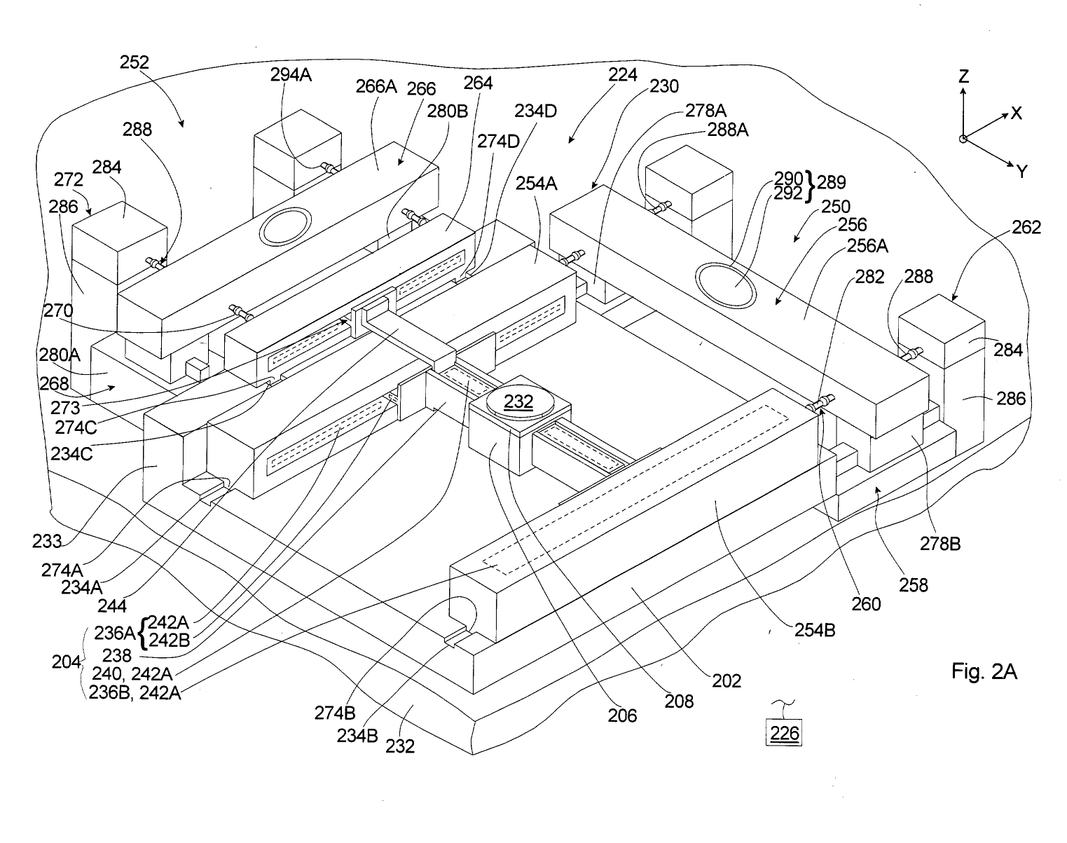

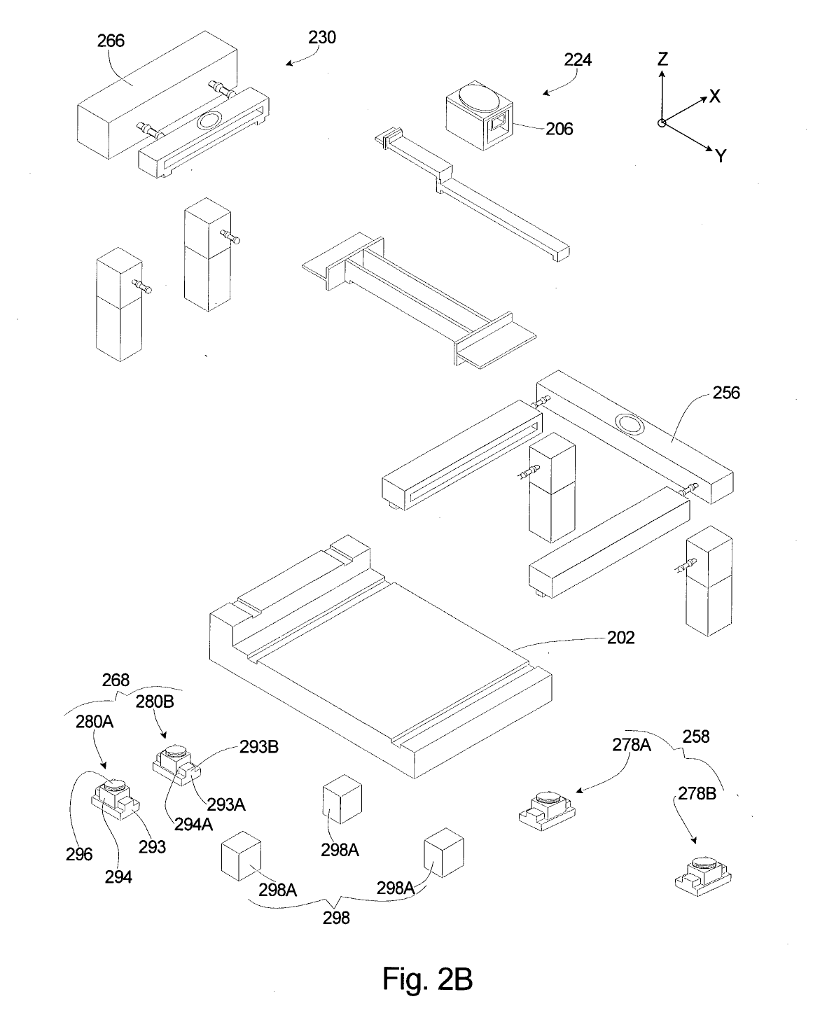

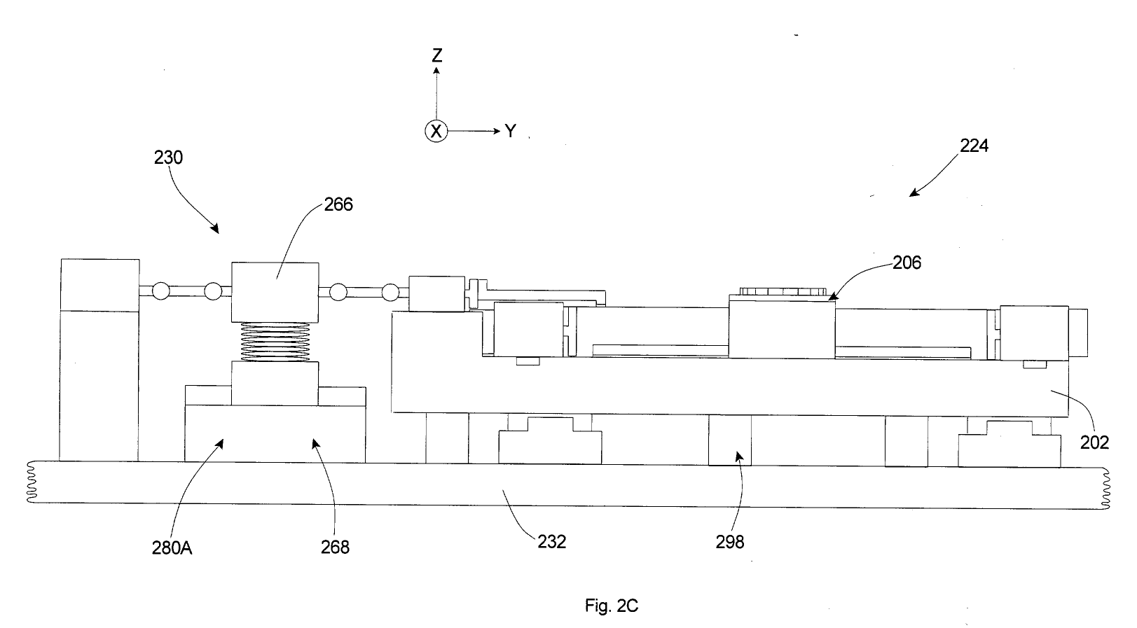

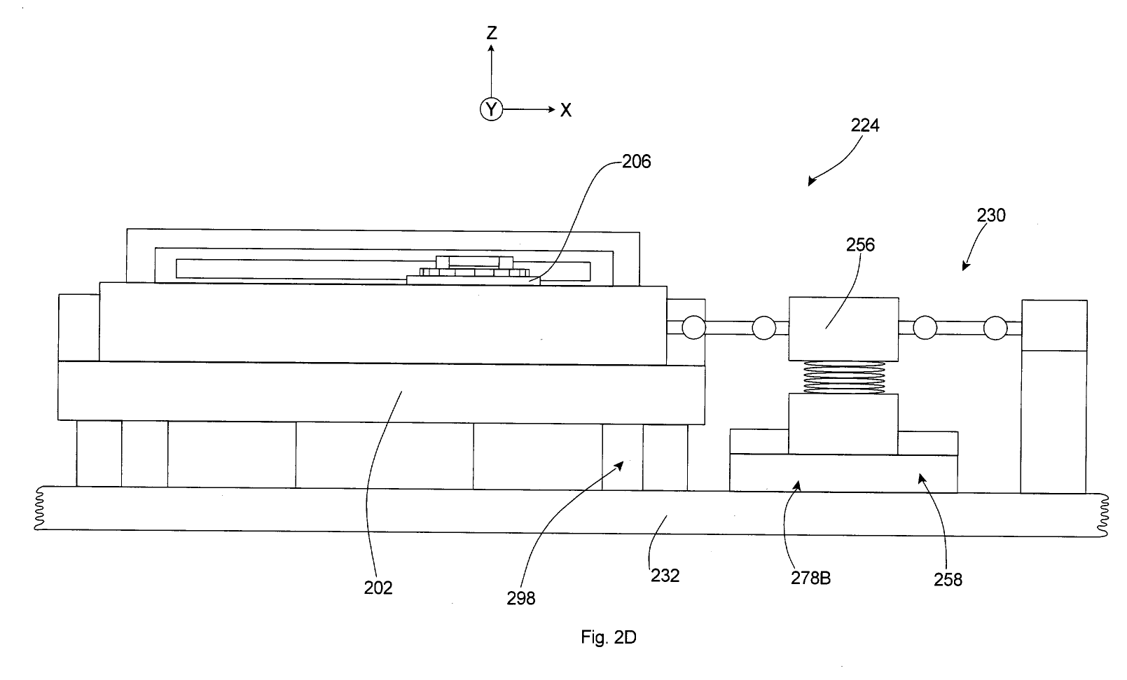

FIG. 2A is a perspective view of a stage assembly 224 that is used to position a device 200 above a mounting base 232. For example, the stage assembly 224 can be used to position a wafer during manufacturing of the semiconductor wafer. Alternatively, the stage assembly 224 can be used to move other types of devices 200 during manufacturing and/or inspection, to move a device under an electron microscope (not shown), or to move a device during a precision measurement operation (not shown). For example, the features of the stage assembly 224 illustrated in FIG. 2A can be incorporated into a reticle stage assembly.

In FIG. 2A, the stage assembly 224 includes a stage base 202, a stage mover assembly 204, a stage 206 including a device table 208, and a reaction frame assembly 230. The design and shape of the components of the stage assembly 224 can be varied to suit design requirements. For example, in FIG. 2A, the stage assembly 224 includes one stage 206 having one device table 208. Alternatively, however, the stage assembly 224 could be designed to include more than one stage 206 and/or more than one device table 208.

The stage mover assembly 204 precisely moves the stage 206 relative to the stage base 202 with one or more degrees of freedom. As an overview, the reaction frame assembly 230 counteracts and reduces the influence of the reaction forces with one or more degrees of freedom from the stage mover assembly 204 on the position of the stage base 202 and the mounting base 232.

The stage base 202 supports some of the components of the stage assembly 224 above the mounting base 232. In FIG. 2A, the stage base 202 is generally rectangular plate shaped and includes a raised section 233. Additionally, the stage base 202 includes (i) a first X base guide 234A, (ii) a spaced apart second X base guide 234B that is substantially parallel to the first X base guide 234A, (iii) a first Y base guide 234C, and (iv) a spaced apart second Y base guide 234D that is substantially parallel to the first Y base guide 234C. The base guides 234A-234D guide movement of a portion of the reaction frame assembly 230. For example, in FIG. 2A, each X base guide 234A, 234B is a rectangular shaped groove in the top of the main body of the stage base 202 and each Y base guide 234C, 234D is a rectangular shaped groove in the top of the raised section 233.

The stage mover assembly 204 controls and moves the stage 206, the device table 208, and the device 200 relative to the stage base 202. In FIG. 2A, the stage 206 is moved by the stage mover assembly 204 relative to the stage base 202 along the X axis, along the Y axis, and about the Z axis (collectively “the planar degrees of freedom”). Additionally, the stage mover assembly 204 could be designed to move and position the stage 206 and the device table 208 along the Z axis, about the X axis and about the Y axis relative to the stage base 202. Alternatively, for example, the stage mover assembly 204 could be designed to move the device table 208 with less than three degrees of freedom, or more than three degrees of freedom.

In FIG. 2A, the stage mover assembly 204 includes a first X stage mover 236A (illustrated in phantom), a second X stage mover 236B (illustrated in phantom), a guide bar 238, and a Y stage mover 240 (illustrated in phantom). The X stage movers 236A, 236B move the guide bar 238, the stage 206 and the device table 208 with a relatively large displacement along the X axis and with a limited range of motion about the Z axis, and the Y stage mover 240 moves the stage 206 and the device table 208 with a relatively large displacement along the Y axis relative to the guide bar 238.

The design of each stage mover 236A, 236B, 240 can be varied to suit the movement requirements of the stage assembly 224. For example, each of the stage movers 236A, 236B, 240 can include one or more rotary motors, voice coil motors, linear motors utilizing a Lorentz force to generate drive force, electromagnetic actuators, or some other force actuators. In the embodiment illustrated in FIG. 2A, each of the stage movers 236A, 236B, 240 is a linear motor. In this embodiment, each of the stage movers 236A, 236B, 240 includes a first mover component 242A and a second mover component 242B that interacts with the first mover component 242A. Further, one of the mover components 242A, 242B includes a magnet array and the other mover component 242B, 242A includes a conductor array. With this design, the control system 226 directs current to the conductor array to move and position one of the arrays relative to the other array.

The guide bar 238 guides the movement of the stage 206 along the Y axis. In FIG. 2A, the guide bar 238 is somewhat rectangular beam shaped. Further, the second component 242B of the first X stage mover 236A is secured to one end of the guide bar 238 and the second component (not shown) of the second X stage mover 236B is secured to the other end of the guide bar 238.

A bearing (not shown) maintains the guide bar 238 spaced apart along the Z axis relative to the stage base 202 and allows for motion of the guide bar 238 along the X axis and about the Z axis relative to the stage base 202. The bearing can be a vacuum preload type fluid bearing that maintains the guide bar 238 spaced apart from the stage base 202 in a non-contact manner. Alternatively, for example, a magnetic type bearing or a rolling type bearing could be utilized.

In FIG. 2A the stage 206 moves with the guide bar 238 along the X axis and about the Z axis and the stage 206 moves along the Y axis relative to the guide bar 238. In this embodiment, the stage 206 is generally rectangular shaped and includes a rectangular shaped opening for receiving the guide bar 238. A bearing (not shown) maintains the stage 206 spaced apart along the Z axis relative to the stage base 202 and allows for motion of the stage 206 along the X axis, along the Y axis and about the Z axis relative to the stage base 202. Further, the stage 206 is maintained apart from the guide bar 238 with opposed bearings (not shown) that allow for motion of the stage 206 along the Y axis relative to the guide bar 238, while inhibiting motion of the stage 206 relative to the guide bar 238 along the X axis and about the Z axis. Each bearing can be a vacuum preload type fluid bearing. Alternatively, for example, a magnetic type bearing or a rolling type bearing could be utilized.

The second mover component (not shown) of the Y stage mover 240 is secured to the stage 206, and the first mover component 242A of the Y stage mover 240 is secured to a Y mover beam 244. A bearing (not shown) maintains the Y mover beam 244 spaced apart along the Z axis relative to the guide bar 238 and allows for motion of the Y mover beam 224 along the Y axis relative to the guide bar 238. The bearing can be a vacuum preload type fluid bearing. Alternatively, for example, a magnetic type bearing or a rolling type bearing could be utilized.

In FIG. 2A, the device table 208 is generally rectangular plate shaped, is fixedly secured to the stage 206 and moves concurrently with the stage 206. Alternatively, for example, the stage mover assembly 204 can include a table mover assembly (not shown) that moves and adjusts the position of the device table 208 relative to the stage 206. For example, the table mover assembly can adjust the position of the device table 208 relative to the stage 206 with six degrees of freedom. Alternatively, for example, the table mover assembly can be designed to move the device table 208 relative to the stage 206 with only three degrees of freedom. The table mover assembly can include one or more rotary motors, voice coil motors, linear motors, electromagnetic actuators, or other type of actuators.

The device table 208 is generally rectangular plate shaped and includes a device holder (not shown) for retaining the device 200. The device holder can include a vacuum chuck, an electrostatic chuck, or some other type of clamp.

The reaction frame assembly 230 counteracts and reduces the influence of the reaction forces from the stage mover assembly 16 on the position of the stage base 202 and the mounting base 232. This reduces the distortion of the stage base 202 and improves the positioning performance of the stage assembly 224. Further, for an exposure apparatus 10 (illustrated in FIG. 1), this allows for more accurate positioning of the semiconductor wafer 14 (illustrated in FIG. 1) relative to a reticle 12 (illustrated in FIG. 1).

The design of the reaction frame assembly 230 and the components of the reaction frame assembly 230 can be varied pursuant to the teachings provided herein. Further, a number of embodiments of the reaction frame assembly 230 are provided herein and discussed below. In each embodiment illustrated, the reaction frame assembly 230 reduces reaction forces transferred to the stage base 202 along the X axis, along the Y axis and/or about the Z axis. Alternatively, the reaction assembly 230 can be designed to reduce reaction forces in more than three or less than three degrees of freedom. Further, in each embodiment, at least a portion and/or all of the reaction frame assembly 230 is supported relative to the mounting base 232 independent to the stage base 202.

FIG. 2A illustrates a first embodiment of the reaction frame assembly 230. In this embodiment, the reaction frame assembly 230 includes a first reaction mass assembly 250 and a second reaction mass assembly 252 that cooperate to reduce the influence of the reaction forces along the X axis, along the Y axis and about the Z axis.

The first reaction mass assembly 250 includes a first X frame 254A, a spaced apart and substantially parallel second X frame 254B, a first mass assembly 256, a first mass support assembly 258, a first mass connector assembly 260, and a first trim mover assembly 262. Somewhat similarly, the second reaction mass assembly 252 includes a Y frame 264, a second mass assembly 266, a second mass support assembly 268, a second mass connector assembly 270, and a second trim mover assembly 272.

Each frame 254A, 254B, 264 is generally rectangular shaped and includes a generally rectangular shaped opening. The first mover component 242A of the first X stage mover 236A is secured to the first X frame 254A, and the first mover component 242A of the second X stage mover 236B is secured to the second X frame 254B. Further, a frame connector 273 connects and couples the Y mover beam 244 to the Y frame 264 and allows the Y mover beam 244 to move relative to the Y frame 264 along the X axis. In FIG. 2A, the frame connector 273 is a voice coil motor that includes a relatively long stator component that is secured to the Y frame 264 and a mover component secured to the Y mover beam 244. Alternatively, for example, the stator component could be relatively short and can be moved with a linear motor (not shown) along the X axis. Still alternatively, a mechanical type connector can be used to connect the Y mover beam 244 to the Y frame 264. With this design, the reaction forces generated by the stage movers 236A, 236B, 240 are transferred to the frames 254A, 254B, 264, respectively.

In FIG. 2A, the X frames 254A, 254B are supported by the stage base 202 and move independently relative to the stage base 202 along the X axis. Because, the X frames 254A, 254B can move independently along the X axis, the reaction frame assembly 230 can transfer reaction forces about the Z axis. Further, the Y frame 264 is supported by the stage base 202 and moves relative to the stage base 202 along the Y axis. In this embodiment, the first X frame 254A includes a first X frame guide 274A that interacts with the first X base guide 234A in the stage base 202 to guide movement of the first X frame 254A along the X axis. Similarly, the second X frame 254B includes a second X frame guide 274B that interacts with the second X base guide 234B in the stage base 202 to guide movement of the second X frame 254B along the X axis. Somewhat similarly, the Y frame 264 includes a first Y frame guide 274C that interacts with the first Y base guide 234C in the stage base 202 and a second Y frame guide 274D that interacts with the second Y base guide 234D in the stage base 202 to guide movement of the Y frame 264 along the Y axis.

A separate bearing (not shown) allows for motion of each of the reaction frames 254A, 254B, 264 relative to the stage base 202. Each bearing can be a vacuum preload type fluid bearing, magnetic type bearing, or a roller type bearing assembly.

The X mass assembly 256 moves along the X axis to reduce the reaction force along the X axis and about the Z axis that is transferred to the stage base 202. Somewhat similarly, the Y mass assembly 266 moves along the Y axis to reduce the reaction force along the Y axis that is transferred to the stage base 202. The design of the mass assemblies 256, 266 can be varied to suit the design requirements of the reaction frame assembly 230. In FIG. 2A, the first mass assembly 256 includes a generally rectangular shaped X mass 256A and the second mass assembly 266 includes a generally rectangular shaped Y mass 266A. Each of the masses 256A, 266A is generally rectangular shaped.

In one embodiment, the ratio of the mass of the mass assemblies 256, 266 to the mass of the stage 206 is relatively high. This will minimize the movement of the mass assemblies 256, 266 and minimize the required travel of the trim mover assemblies 262, 272. A suitable ratio of the mass of the mass assemblies 256, 266 to the mass of the stage 202 is between approximately 2:1 and 10:1. A larger mass ratio is better, but is limited by the physical size of the reaction frame assembly 230.

The first mass support assembly 258 supports the first mass assembly 256 relative to the mounting base 232 and allows for motion of the first mass assembly 256 relative to the mounting base 232 along the X axis. Somewhat similarly, the second mass support assembly 268 supports the second mass assembly 266 relative to the mounting base 232 and allows for motion of the second mass assembly 266 relative to the mounting base 232 along the Y axis. In FIG. 2A, the first mass support assembly 258 includes a first X support 278A and a spaced apart second X support 278B that cooperate to support the first mass assembly 256, and to permit the first mass assembly 256 to move in the X direction. Somewhat similarly, the second mass support assembly 268 includes a first Y support 280A and a spaced apart second Y support 280B that cooperate to support the second reaction mass assembly 266, and to permit the second reaction mass assembly 266 to move in the Y direction.

The first mass connector assembly 260 mechanically connects and couples the X frames 254A, 254B to the first mass assembly 256. Somewhat similarly, the second mass connector assembly 270 mechanically connects and couples the Y frame 264 to the second mass assembly 266. In FIG. 2A, (i) the first mass connector assembly 260 allows for relative motion along the Z axis, along the Y axis, about the X axis, about the Y axis, and about the Z axis and inhibits relative motion along the X axis between the X frames 254A, 254B and the first mass assembly 256 and (ii) the second mass connector assembly 270 allows for relative motion along the Z axis, along the X axis, about the X axis, about the Y axis, and about the Z axis and inhibits relative motion along the Y axis between the Y frame 264 and the second mass assembly 266. In FIG. 2A, each mass connector assembly 260, 270, includes a pair of spaced apart connectors 282. In one embodiment, each connector 282 is a link that is relatively stiff along one degree of freedom and relatively flexible with five degrees of freedom. In this embodiment, each link includes a rigid bar and a pair of spaced apart flexures or ball joints that allow for motion with five degrees of freedom. Alternatively, each connector assembly 260, 270 can include more than two or less than two connectors 282, or each connector 282 can be a stiff rod. Still alternatively, for example, each connector 282 can utilize electromagnetic means. In one embodiment, the connectors 282 of the first mass connector assembly 260 are in-line with the X frames 254A, 254B, and the first mass assembly 256.

The first trim mover assembly 262 adjusts and/or resets the position of the first mass assembly 256, cancels any positional errors of the first mass assembly 256 and/or cancels any steady-state velocity of the first mass assembly 256. Somewhat similarly, the second trim mover assembly 272 adjusts and/or resets the position of the second mass assembly 266, cancels any positional errors of the second mass assembly 266 and/or cancels any steady-state velocity of the second mass assembly 266. For example, in FIG. 2A, the first trim mover assembly 262 adjusts the position of the first mass assembly 256 along the X axis and about the Z axis and the second trim mover assembly 272 adjusts the position of the second mass assembly 266 along the Y axis.

Each of trim mover assembly 262, 272 can include one or more movers 284. For example, each of the movers 284 can be a rotary motor, a voice coil motor, a linear motor, an electromagnetic actuator, and/or another type of force actuator. In the embodiment illustrated in FIG. 2A, each trim mover assembly 262, 272 includes two movers 284, and each of the movers 284 is a voice coil motor that includes a stator 286 (illustrated in phantom), e.g. a magnet array and a moving part 288 (illustrated in phantom), e.g. a coil array. In FIG. 2A, one of the movers 284 is embedded into each one of the supports 278A, 278B, 280A, 280B. With this design, the control system 226 directs current to the movers 284 to control the positions of the mass assemblies 256, 266.

With this design of the stage assembly 224, through the principle of conservation of momentum, movement of the stage 206 and guide bar 238 with the X stage movers 236A, 236B along the X axis in one direction, generates an equal but opposite X reaction force that moves the X frames 254A, 254B and the first mass assembly 256 in the opposite direction along the X axis. Movement of the stage 206 with the Y stage mover 240 along the Y axis in one direction, creates an equal but opposite Y reaction force on the Y frame 264 and the second mass assembly 266 along the Y axis. Additionally, movement of the stage 206 about the Z axis with the X stage movers 236A can generate a theta Z reaction force (torque) about the Z axis in the opposite direction that moves the X frames 254A, 254B and the first mass assembly 256.

Additionally, the reaction frame assembly 230 can include one or more torque reducers 289 that reduce the magnitude of torque experienced by one or both of the mass assemblies 256, 266. In FIG. 2A, each of the mass assemblies 256, 266 includes a torque reducer 289. In this embodiment, each torque reducer 289 includes a flywheel 290 and a flywheel mover 292. In one embodiment, the flywheel 290 is a right cylindrical shaped mass and the flywheel mover 292 is a rotary motor. With this design, for example, when the first mass assembly 256 is experiencing torque, e.g. rotational force about the Z axis in a first rotational direction, the control system 226 can direct current to the flywheel mover 292 secured to the X mass 256A to rotate the flywheel 290 about the Z axis in the first rotational direction. This causes a theta Z correction torque from the flywheel mover 292 to be imparted upon the X mass 256A about the Z axis in a second rotational direction that is opposite to the first rotational direction. Similarly, for example, when the second mass assembly 266 is experiencing torque, e.g. rotational force about the Z axis in a first rotational direction, the control system 226 can direct current to the flywheel mover 292 secured to the Y mass 266A to rotate the flywheel 290 about the Z axis in the first rotational direction. This causes a theta Z correction torque from the flywheel mover 292 to be imparted upon the Y mass 266A about the Z axis in the second rotational direction that counteracts, reduces and/or cancels the theta Z reaction force. In one embodiment, the correction theta Z torque generated by the torque reducer 289 is approximately equal to the theta Z reaction force. Alternatively, the correction theta Z force can be greater or less than the theta Z reaction force.

The control system 226 directs and controls current to the trim mover assemblies 262, 272 and the mass support assemblies 258, 268 to control the position of the mass assemblies 256, 266.

FIG. 2B is an exploded perspective view of the stage assembly 224 of FIG. 2A including the stage base 202, the stage 206, and the reaction frame assembly 230. FIG. 2B also illustrates each support 278A, 278B, 280A, 280B in greater detail. In this embodiment, each support 278A, 278B, 280A, 280B includes a guide 293, a follower 294, a bearing (not shown) and a mass adjuster 296. For each support assembly 278A, 278B, 280A, 280B, the guide 293 and the follower 294 cooperate to allow for motion along one axis and inhibit motion in the other five degrees of freedom. In FIG. 2B, for each support 278A, 278B, 280A, 280B, (i) the guide 293 includes a generally rectangular shaped guide base 293A that is secured to the mounting base 232 (illustrated in FIG. 2A) and a rectangular shaped guide protrusion 293B that extends above the guide base 293A, (ii) the follower 294 is generally rectangular shaped and includes a generally rectangular shaped channel 294A in the bottom that receives the guide protrusion 293B, (iii) the bearing allows for motion of the follower 294 relative to the guide 293 along one axis, and (iv) the mass adjuster 296 adjusts the position of the respective mass assembly 256, 266 relative to the mounting base 232. With this design, the position of the mass assemblies 256, 266 can be adjusted along the Z axis to follow the position of the stage base 202 and/or the stage 206 along the Z axis. Each bearing can be a vacuum preload type fluid bearing, magnetic type bearing, or a roller type bearing type assembly.

In FIG. 2B, each mass adjuster 296 adjusts the position of the respective mass assembly 256, 266 along the Z axis relative to the mounting base 232. Further, the mass adjusters 296 of the first mass support assembly 258 can cooperate to adjust the position of the first mass assembly 256 about the X axis. Similarly, the mass adjusters 296 of the second mass support assembly 268 can cooperate to adjust the position of the second mass assembly 266 about the Y axis. Moreover, each mass adjuster 296 can also reduce the effect of vibration of the respective mass assemblies 256, 266 from causing vibration on the mounting base 232. Each mass adjuster 296 can include an air spring, a vibration isolator, bellows, a pneumatic cylinder and/or one or more actuators. Suitable mass adjusters 296 are sold by Technical Manufacturing Corporation, located in Peabody, Mass., or Newport Corporation located in Irvine, Calif. In one embodiment, the mass adjusters 296 have a relatively high lateral stiffness so that the follower 294 moves with the respective mass adjusters 296 and with the respective mass 256A, 266A.

With this design, the center of gravity of the mass assemblies 256, 266 does not move relative to the mass adjusters 296. Thus, active control of the mass adjusters 296 is not necessary. Further, the position of the bearing of each support 278A, 278B, 280A, 280B does not change. Thus, mass assemblies 256, 266 should not tilt. Moreover, the mass assemblies 256, 266 are isolated from bearing noise. Additionally, with this design, the position of the first mass assembly 256 can be adjusted along the Z axis, about the Y axis and about the X axis relative to the mounting base 232. Similarly, the position of the second mass assembly 266 can be adjusted along the Z axis, about the Y axis and about the X axis relative to the mounting base 232.

Additionally, in FIG. 2B, the mass adjusters 296 are positioned between the follower 294 and the respective mass assembly 256, 266. Alternatively, for one or more of the supports 278A, 278B, 280A, 280B, the mass adjuster 296 can be positioned between the guide 293 and the mounting base 232.

FIG. 2B also illustrates that the stage assembly 224 includes a base adjuster assembly 298 that supports the stage base 202. The base adjuster assembly 298 adjusts the position of the stage base 202 relative to the mounting base 232 (illustrated in FIG. 2A). With this design, the position of the stage base 232 can be adjusted along the Z axis, about the Y axis and about the X axis, relative to the mounting base 232 and the mass assemblies 256, 266. Moreover, the base adjuster assembly 298 can also reduce the effect of vibration of the mounting base 232 from causing vibration on the stage base 202. For example, the base adjuster assembly 298 can include three spaced apart base adjusters 298A. Each base adjuster 298A can include an air spring, a vibration isolator, bellows, a pneumatic cylinder and/or one or more an actuators. Suitable base adjusters 298A are sold by Technical Manufacturing Corporation, located in Peabody, Mass., or Newport Corporation located in Irvine, Calif.

FIG. 2C is a front plan view of the stage assembly 224 of FIG. 2A including the stage base 202, the stage 206, and the reaction frame assembly 230. FIG. 2C also illustrates the first Y support 280A of the second mass support assembly 268 in greater detail. In this embodiment, the second mass support assembly 268 allows the second mass assembly 266 to move along the Y axis and adjusts the position of the second mass assembly 266 along the Z axis and about the Y axis relative to the mounting base 232. With this design, the position of the second mass assembly 266 can be adjusted to follow somewhat the position of the stage base 202. Further, FIG. 2C illustrates that the base adjuster assembly 298 supports the stage base 202 relative to the mounting base 232.

FIG. 2D is a side plan view of the stage assembly 224 of FIG. 2A including the stage base 202, the stage 206, and the reaction frame assembly 230. FIG. 2D also illustrates the second X support 278B of the first mass support assembly 258 in greater detail. In this embodiment, the first mass support assembly 258 allows the first mass assembly 256 to move along the X axis and adjusts the position of the first mass assembly 256 along the Z axis, and about the X axis relative to the mounting base 232. With this design, the position of the first mass assembly 256 can be adjusted to follow somewhat the movement of the stage base 202. Further, FIG. 2D illustrates that the base adjuster assembly 298 supports the stage base 202 relative to the mounting base 232.

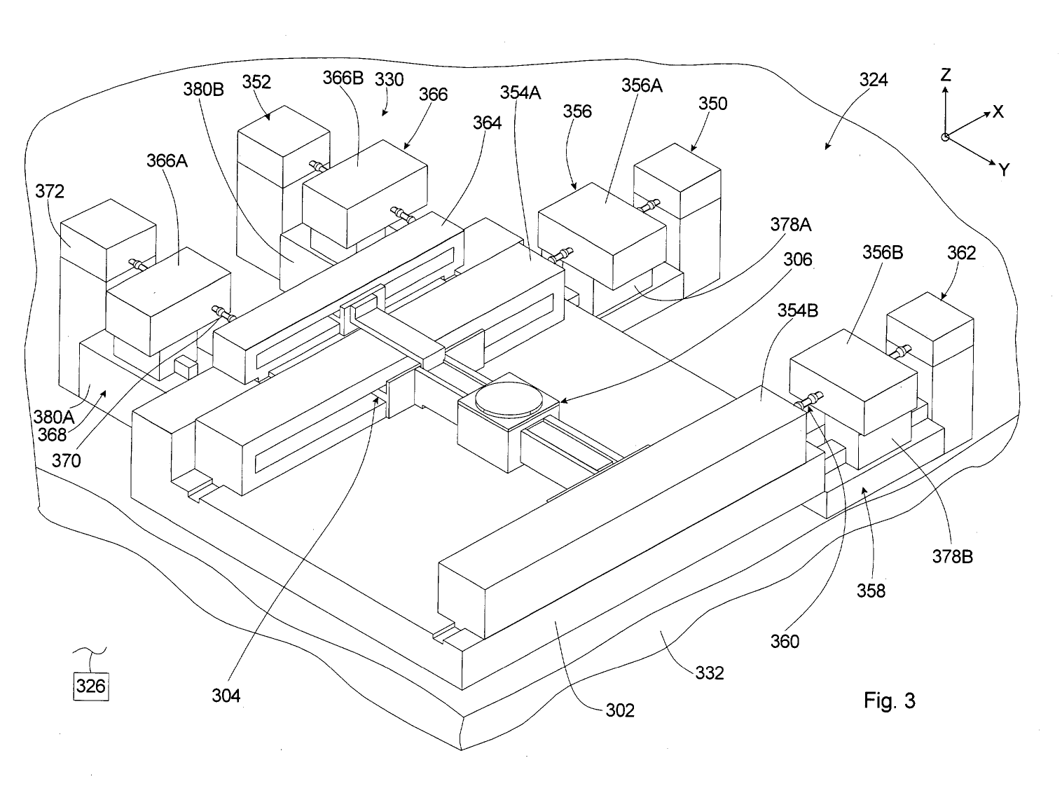

FIG. 3 is a perspective view of another embodiment of a stage assembly 324 that can be used in the exposure apparatus 10 of FIG. 1 and a mounting base 332. In this embodiment, the stage assembly 324 includes a stage base 302, a stage mover assembly 304, a stage 306, a control system 326 and a reaction frame assembly 330 that are somewhat similar to the corresponding components described above and illustrated in FIGS. 2A-2D. In this embodiment, the reaction frame assembly 330 includes (i) a first reaction mass assembly 350 having a first X frame 354A, a second X frame 354B, a first mass assembly 356, a first mass support assembly 358, a first mass connector assembly 360, and a first trim mover assembly 362 (illustrated in phantom), and (ii) a second reaction mass assembly 352 including a Y frame 364, a second mass assembly 366, a second mass support assembly 368, a second mass connector assembly 370, and a second trim mover assembly 372 (illustrated in phantom) that are somewhat similar to the corresponding components described above and illustrated in FIGS. 2A-2D. However, in this embodiment, the first mass assembly 356 includes a first X mass 356A and a spaced apart, second X mass 356B and the second mass assembly 366 includes a first Y mass 366A and a spaced apart, second Y mass 366B. In this embodiment, (i) the first X mass 356A is supported by the first X support 378A, (ii) the second X mass 356B is supported by the second X support 378B, (iii) the first Y mass 366A is supported by the first Y support 380A, and (iv) the second Y mass 366B is supported by the second Y support 380B.

With this design, when the stage mover assembly 304 moves the stage 306 along the X axis, the X masses 356A, 356B are moved along the X axis in the opposite direction. Further, when the stage mover assembly 304 moves the stage 306 along the Y axis, the Y masses 366A, 366B are moved along the Y axis in the opposite direction.

In this embodiment, the X masses 356A, 356B can move independently relative to each other along the X axis because each X mass 356A, 356B is coupled to a separate X frame 354A, 354B. Further, the first trim mover assembly 362 can individually adjust the position of the X masses 356A, 356B along the X axis. In one embodiment, the second trim mover assembly 372 is used to keep the Y masses 366A, 366B at approximately the same location along the Y axis.

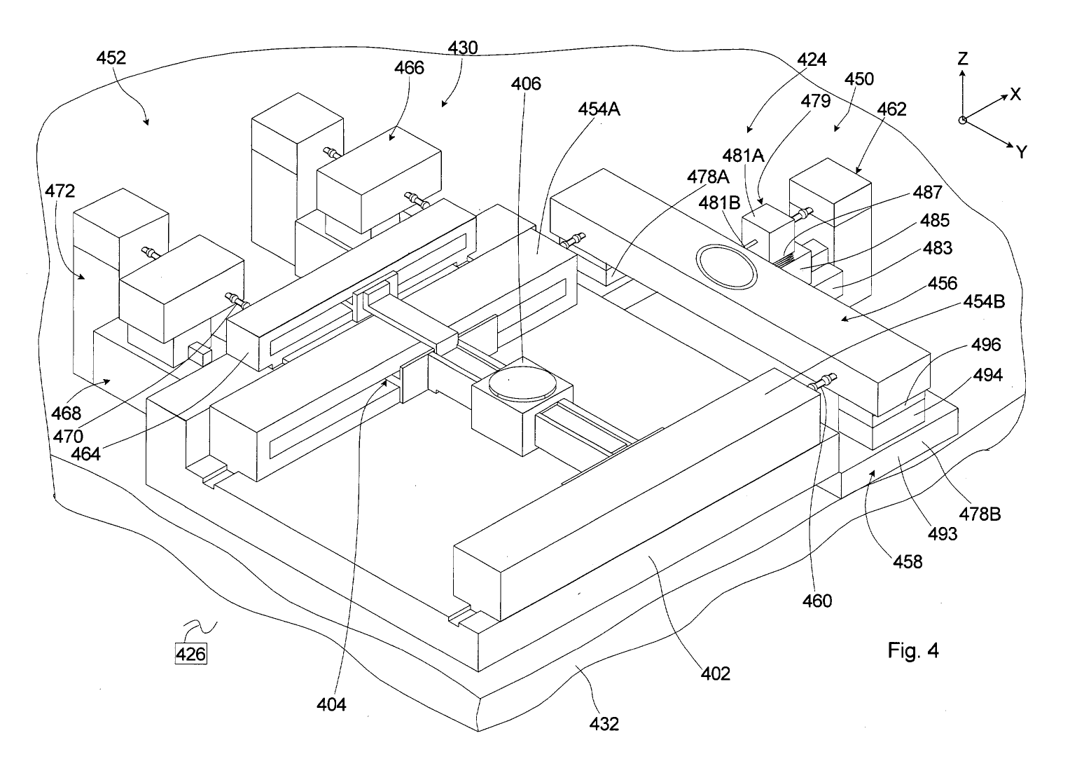

FIG. 4 is a perspective view of another embodiment of a stage assembly 424 that can be used in the exposure apparatus 10 of FIG. 1 and a mounting base 432. In this embodiment, the stage assembly 424 includes a stage base 402, a stage mover assembly 404, a stage 406 and a control system 426 that are somewhat similar to the corresponding components described above and illustrated in FIGS. 2A-2D. However, in this embodiment, the reaction frame assembly 430 is slightly different.

In particular, in this embodiment the reaction frame assembly 430 again includes (i) a first reaction mass assembly 450 including a first X frame 454A, a second X fame 454B, a first mass assembly 456, a first mass support assembly 458, a first mass connector assembly 460, and a first trim mover assembly 462, and (ii) a second reaction mass assembly 452 including a Y frame 464, a second mass assembly 466, a second mass support assembly 468, a second mass connector assembly 470, and a second trim mover assembly 472 that are somewhat similar to the corresponding components described above and illustrated in FIG. 3.

In the embodiment illustrated in FIG. 4, the first mass assembly 456 and the first mass connector assembly 460 are somewhat similar to the corresponding components described above and illustrated in FIGS. 2A-2D. However, the first mass support assembly 458, and the first trim mover assembly 462 differ slightly from the embodiments described above. More specifically, in FIG. 4, the first mass support assembly 458 includes (i) a first X support 478A, (ii) a spaced apart second X support 478B, and (iii) an X pivot assembly 479. In this embodiment, the X supports 478A, 478B cooperate to allow for motion of the first mass assembly 456 along the X axis, along the Y axis and about the Z axis. Further, the X supports 478A, 478B can be used to adjust the position of the first mass assembly 456 along the Z axis, about the X axis and/or about the Y axis. Each X support 478A, 478B includes an X guide 493, an X follower 494, a bearing (not shown) that allows the X follower 494 to move along the X axis, along the Y axis, and about the Z axis relative to the X guide 493, and a mass adjuster 496. For each X support 478A, 478B, the X guide 493, the X follower 494, and the bearing cooperate to allow for motion along X axis, along the Y axis, and about the Z axis. As illustrated, the top of the X guide 493 is planar and the follower 494 slides relative to the X guide 493 on a bearing, e.g. an air bearing. The mass adjuster 496 adjusts the position of the first mass assembly 456 along the Z axis, about the X axis and/or about the Y axis relative to the mounting base 432. Moreover, each mass adjuster 496 can also reduce the effect of vibration of the first mass assembly 456 from causing vibration on the mounting base 432.

The X pivot assembly 479 guides the movement of the first mass assembly 456 along the X axis and allows the first mass assembly 456 to pivot about the Z axis but restrains the first mass assembly 456 from moving along the Y axis. In FIG. 4, the X pivot assembly 479 includes a pivot block 481A, a pivot connector 481B, a pivot guide 483, a pivot follower 485, a bearing (not shown) and a pivot adjuster 487. For the X pivot assembly 479, the guide 483 and the follower 485 cooperate to allow for motion along the X axis and inhibit motion in the other five degrees of freedom. In FIG. 4, (i) the pivot guide 483 includes a generally rectangular shaped guide base that is secured to the mounting base 432 and a rectangular shaped guide protrusion that extends above the guide base, (ii) the follower 485 is generally rectangular shaped and includes a generally rectangular shaped channel in the bottom that receives the guide protrusion, (iii) the bearing allows for motion of the follower 485 relative to the guide 483 along the X axis, and (iv) the pivot adjuster 487 adjusts the position of the pivot block 481A relative to the mounting base 432. The pivot adjuster 487 can include an air spring, a vibration isolator, bellows, a pneumatic cylinder and/or one or more actuators. With this design, the position of the pivot connector assembly 481 can be adjusted along the Z axis to follow the position of the stage base 402 and/or the first mass assembly 456 along the Z axis. Each bearing can be a vacuum preload type fluid bearing, magnetic type bearing, or a roller type bearing type assembly.

The pivot connector 481B connects the first mass assembly 456 to the pivot block 481A and allows the first mass assembly 456 to rotate about the Z axis but inhibits relative movement along the X axis and along the Y axis. As an example, the pivot connector 481B can be a flexure.

The first trim mover assembly 462 adjusts and/or resets the position of the first mass assembly 456, cancels any positional errors of the first mass assembly 456 and/or cancels any steady-state velocity of the first mass assembly 456. In FIG. 4, the trim mover assembly 462 includes a mover. For example, the mover can be a rotary motor, a voice coil motor, a linear motor, an electromagnetic actuator, and/or another type of force actuator.

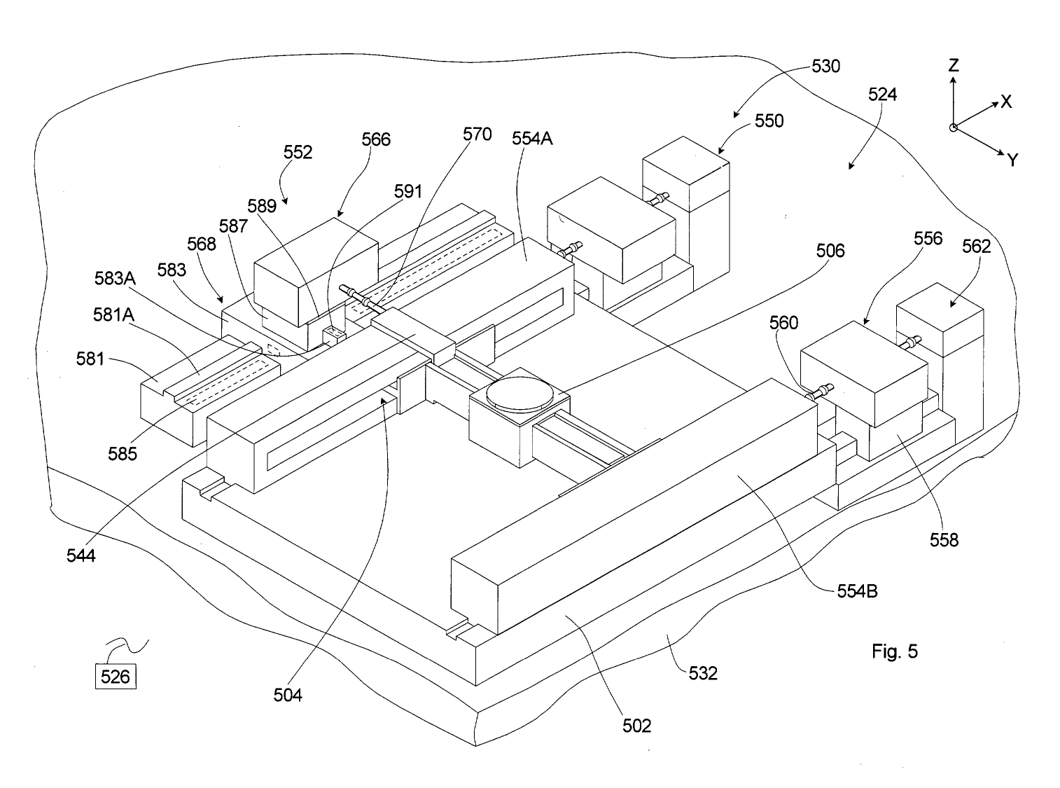

FIG. 5 is a perspective view of another embodiment of a stage assembly 524 that can be used in the exposure apparatus 10 of FIG. 1 and a mounting base 532. In this embodiment, the stage assembly 524 includes a stage base 502, a stage mover assembly 504, a stage 506 and a control system 526 that are somewhat similar to the corresponding components described above and in FIGS. 2A-2D. However, in this embodiment, the reaction frame assembly 530 is slightly different.

In particular, in this embodiment the reaction frame assembly 530 again includes (i) a first reaction mass assembly 550 including a first X frame 554A, a second X fame 554B, a first mass assembly 556, a first mass support assembly 558, a first mass connector assembly 560, and a first trim mover assembly 562 that are somewhat similar to the corresponding components described above and illustrated in FIG. 3, and (ii) a second reaction mass assembly 552 including a second mass assembly 566, a combination support and trim assembly 568 and a second mass connector assembly 570.

In the embodiment illustrated in FIG. 5, the second mass assembly 566 and the second mass connector assembly 570 are somewhat similar to the corresponding components described above and illustrated in FIGS. 2A-2D. However, in FIG. 5, the second mass connector assembly 570 directly couples the second mass assembly 566 to the Y mover beam 544.

Further, the combination support and trim assembly 568 (i) moves the second mass assembly 566 along the X axis to follow the movement of the stage 506 along the X axis, (ii) allows the second mass assembly 566 to move along the Y axis, and (iii) corrects the position of the second mass assembly 566 along the Y axis. In FIG. 5, the support and trim assembly 568 includes (i) an X guide 581 including an X guide protrusion 581A, (ii) an X follower 583 that includes a generally rectangular shaped channel in the bottom that receives the guide protrusion 581A and a rectangular shaped follower protrusion 583A in the top of the X follower 583, (iii) an X bearing (not shown) that allows the X follower 583 to move along the X axis relative to the X guide 581, (iv) an X mover 585 (illustrated in phantom) that moves the X follower 583 along the X axis relative the X guide 581, (v) a Y follower 587 that includes a generally rectangular shaped channel in the bottom that receives the follower protrusion 583A, (vi) a Y bearing (not shown) that allows the Y follower to move along the Y axis relative to the X follower 583, (vii) a mass adjuster 589 that adjusts the position of the second mass assembly 566 along the Z axis, about the X axis and/or about the Y axis relative to the mounting base 532, and (viii) a Y trim mover 591 (illustrated in phantom) that adjusts and/or resets the position of the second mass assembly 566, cancels any positional errors of the second mass assembly 566 and/or cancels any steady-state velocity of the second mass assembly 566.

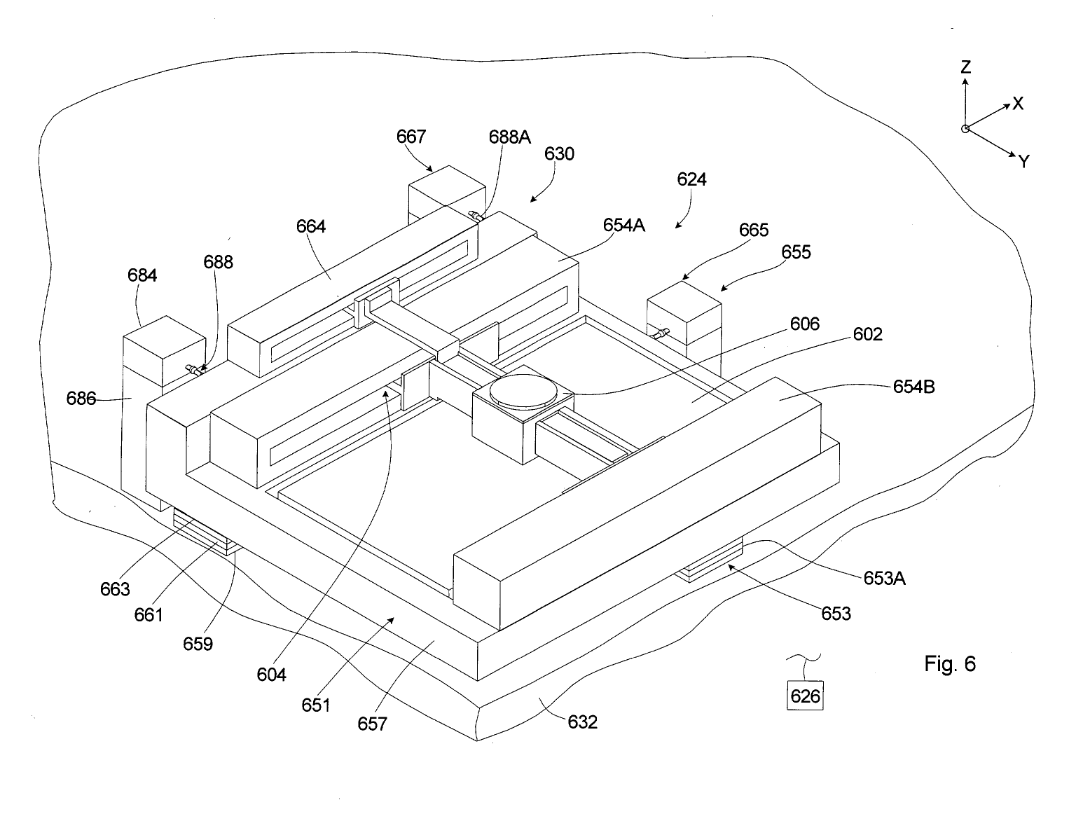

FIG. 6 is a perspective view of another embodiment of a stage assembly 624 that can be used in the exposure apparatus 10 of FIG. 1 and a mounting base 632. In this embodiment, the stage assembly 624 includes a stage mover assembly 604, a stage 606 and a control system 626 that are somewhat similar to the corresponding components described above and in FIGS. 2A-2D. However, in this embodiment, the stage base 602 and the reaction frame assembly 630 are slightly different.

In particular, in this embodiment, the stage base 602 is generally rectangular plate shaped and supports the stage 606. Further, the reaction frame assembly 630 includes a reaction mass assembly 651, mass support assembly 653, and a trim mover assembly 655. In FIG. 6, the reaction mass assembly 651 includes (i) a rectangular frame shaped reaction base 657 that encircles the stage base 602, (ii) a first X frame 654A that is secured to the reaction base 657, (iii) a second X frame 654B that is secured to the reaction base 657, and (iv) a Y frame 664 that is secured to the reaction base 657.

The mass support assembly 653 allows the reaction mass assembly 651 to move along the X axis, along the Y axis and about the Z axis and adjusts the position of the reaction mass assembly 651 along the Z axis, about the X axis and about the Y axis. In FIG. 6, the mass support assembly 653 includes three spaced apart mass supports 653A (only two are illustrated). In this embodiment, each of the mass supports 653A includes (i) a mass guide 659 that is secured to the mounting base 632, (ii) a mass follower 661, (iii) a bearing (not shown) that allows the mass follower 661 to move along the X axis, along the Y axis and about the Z axis relative to the mass guide 659, and (iv) a mass adjuster 663 that adjusts the position of the reaction mass assembly 651 along the Z axis. The mass adjuster 663 can include an air spring, vibration isolator, bellows, a pneumatic cylinder and/or one or more actuators. With this design the position of the reaction mass assembly 651 along the Z axis, about the X axis and about the Y axis can be adjusted to correspond to the position of the stage base 602.

In this embodiment, the top of the mass guide 659 is planar shaped. A bearing, e.g. an air bearing, supports the mass follower 661 relative to the mass guide 659 and allows the mass follower 661 to move relative to the mass guide 659.

The trim mover assembly 655 adjusts and/or resets the position of the reaction mass assembly 651, cancels any positional errors of the reaction mass assembly 651 and/or cancels any steady-state velocity of the reaction mass assembly 651. In FIG. 6, the trim mover assembly 655 includes a X mover assembly 665 that moves the reaction mass assembly 651 along the X axis, a pair of spaced apart Y mover assemblies 667 that move the reaction mass assembly 651 along the Y axis and about the Z axis and a trim connector assembly 688 that connects and couples the mover assemblies 665, 667 to the reaction mass assembly 651. In this embodiment, each mover assembly 665, 667 includes one or more movers 684 (illustrated as a box) and a mover mount 686 that mounts the movers 684 to the mounting base 632. For example, each of the movers 684 can be a rotary motor, a voice coil motor, a linear motor, an electromagnetic actuator, and/or another type of force actuator. With this design, the control system 626 directs current to the movers 684 to control the position of the reaction mass assembly 651.

In FIG. 6, the trim connector assembly 688 (i) allows the reaction mass assembly 651 to move along the Z axis, about the X axis and about the Y axis relative to the movers 684 and (ii) inhibits the reaction mass assembly 651 from moving along the X axis relative to the X mover assembly 665 and along the Y axis relative to the Y mover assemblies 667. In FIG. 6, the trim connector assembly 688 includes three connectors 688A. As an example, each connector 688A can be a flexure that includes a link and a pair of spaced apart joints that allow for motion with five degrees of freedom.

With this design, the movement of the stage 606 by the stage mover assembly 604 in one direction causes the reaction base 657 to move in the opposite direction.

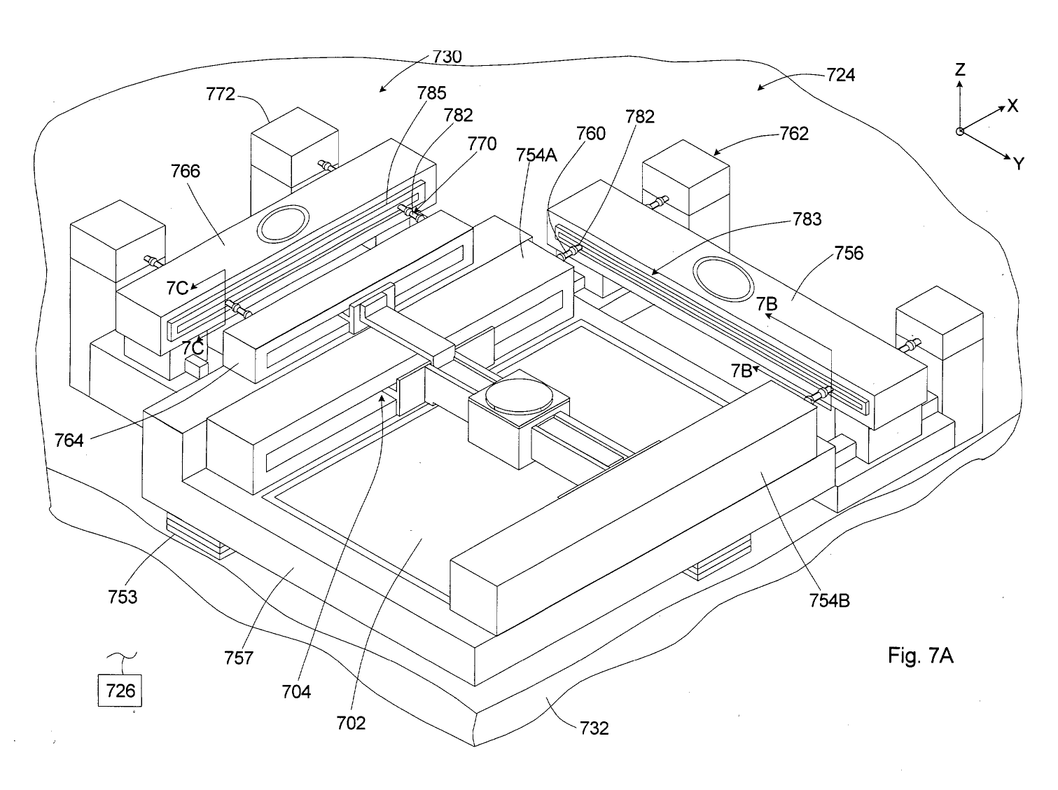

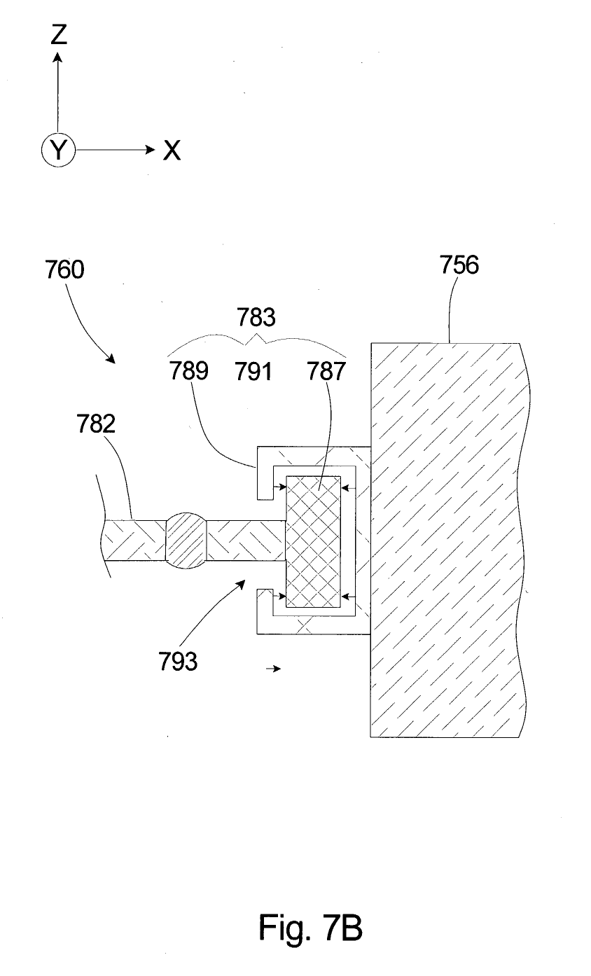

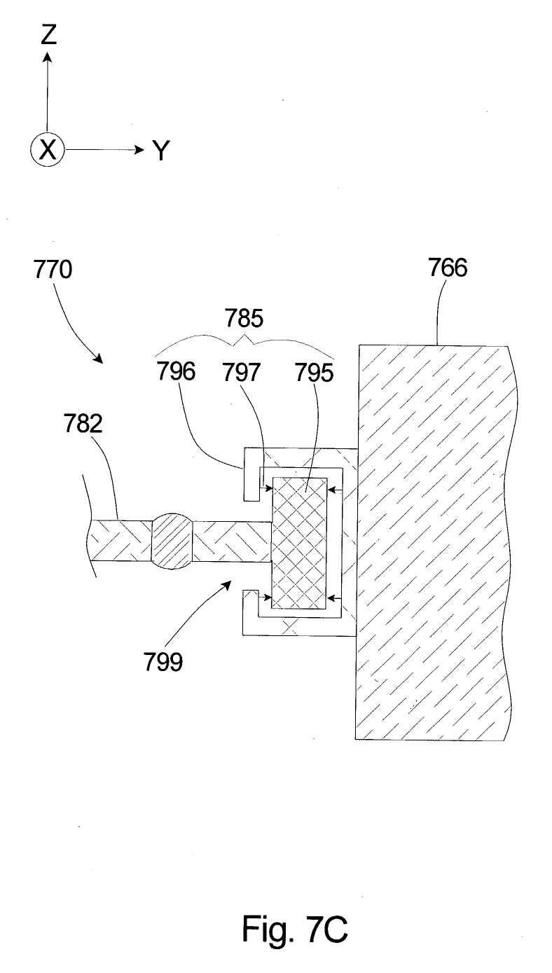

FIG. 7A is a perspective view of yet another embodiment of a stage assembly 724 that can be used in the exposure apparatus 10 of FIG. 1 and a mounting base 732. In this embodiment, the stage assembly 724 includes a stage mover assembly 704, a stage 706 and a control system 726 that are somewhat similar to the corresponding components described above and in FIGS. 2A-2D. However, in this embodiment, the stage base 702 and the reaction frame assembly 730 are slightly different.

In particular, the stage base 702 is similar to the stage base 602 described above and illustrated in FIG. 6. Further, the reaction frame assembly 730 includes (i) a reaction base 757 and a mass support assembly 753 that are somewhat similar to the corresponding components described above and illustrated in FIG. 6, and (ii) a first mass assembly 756, a second mass assembly 766, a first trim mover assembly 762, and a second trim mover assembly 772 that are similar to the corresponding components described above and illustrated in FIGS. 2A-2D. However, in FIG. 7A, the reaction frame assembly 730 includes a first mass connector assembly 760 and a second mass connector assembly 770 that are slightly different than the corresponding components described above and illustrated in FIGS. 2A-2D.

In FIG. 7A, the first mass connector assembly 760 allows for relative motion along the Z axis, along the Y axis, about the X axis, about the Y axis, and about the Z axis and inhibits relative motion along the X axis between the X frames 754A, 754B and the first mass assembly 756 and (ii) the second mass connector assembly 770 allows for relative motion along the Z axis, along the X axis, about the X axis, about the Y axis, and about the Z axis and inhibits relative motion along the Y axis between the Y frame 764 and the second mass assembly 766. In FIG. 7A, the first mass connector assembly 760 includes a pair of spaced apart connectors 782 and a first slider connector assembly 783. Similarly, the second mass connector assembly 770 includes a pair of spaced apart connectors 782 and a second slider connector assembly 785. In FIG. 7A, each connector 782 is similar to the corresponding components described above and illustrated in FIGS. 2A-2D. Alternatively, for example, each connector 782 can be a solid rod.

FIG. 7B illustrates a cross-sectional view taken on line 7B-7B of FIG. 7A. More specifically, FIG. 7B illustrates a portion of one the connectors 782, a portion of the first slider connector assembly 783 and a portion of the first mass assembly 756. In this embodiment, the first slider connector assembly 783 includes (i) a first slider 787, (ii) a first slider guide 789 that receives the first slider 787, and (iii) a first bearing assembly 791 (illustrated as arrows) that allows the first slider 787 to slide along the first slider guide 789 along the Y axis but inhibits motion of the first slider 787 relative to the first slider guide 789 along the X axis and about the X, Y, and Z axes. In FIG. 7B, (i) the first slider 787 is generally rectangular shaped and is secured to the end of the connector 782, (ii) the first slider guide 789 is somewhat rectangular tube shaped with a rectangular shaped slot 793 for receiving the connector 782 and is secured to the first mass assembly 756, and (iii) the first bearing assembly 791 is a pair of opposed fluid bearings. Alternatively, for example, the first slider 787 could be secured to the first mass assembly 756, the first slider guide 789 could be secured to the connector 782, and/or the first bearing assembly 791 can include a rolling type bearing. Still alternatively, the first slider connector assembly could be an electromagnetic type connector.

FIG. 7C illustrates a cross-sectional view taken on line 7C-7C of FIG. 7A. More specifically, FIG. 7C illustrates a portion of one the connectors 782, a portion of the second slider connector assembly 785 and a portion of the second mass assembly 766. In this embodiment, the second slider connector assembly 785 includes (i) a second slider 795, (ii) a second slider guide 796 that receives the second slider 795, and (iii) a second bearing assembly 797 (illustrated as arrows) that allows the second slider 795 to slide along the second slider guide 796 along the X axis but inhibits motion of the second slider 795 relative to the second slider guide 796 along the Y axis and about the X, Y, and Z axes. In FIG. 7C, (i) the second slider 795 is generally rectangular shaped and is secured to the end of the connector 782, (ii) the second slider guide 796 is somewhat rectangular tube shaped with a rectangular shaped slot 799 for receiving the connector 782 and is secured to the second mass assembly 766, and (iii) the second bearing assembly 797 is a pair of opposed fluid bearings. Alternatively, for example, the second slider 795 could be secured to the second mass assembly 766, the second slider guide 796 could be secured to the connector 782, and/or the second bearing assembly 797 can include a rolling type bearing.

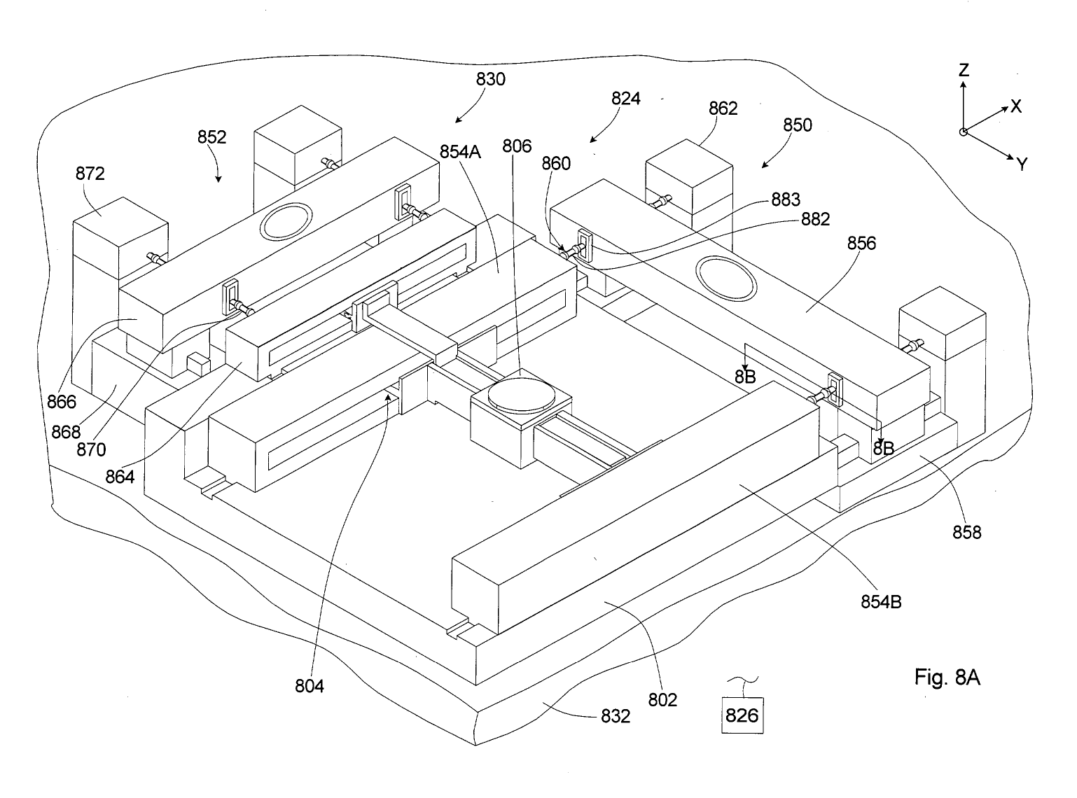

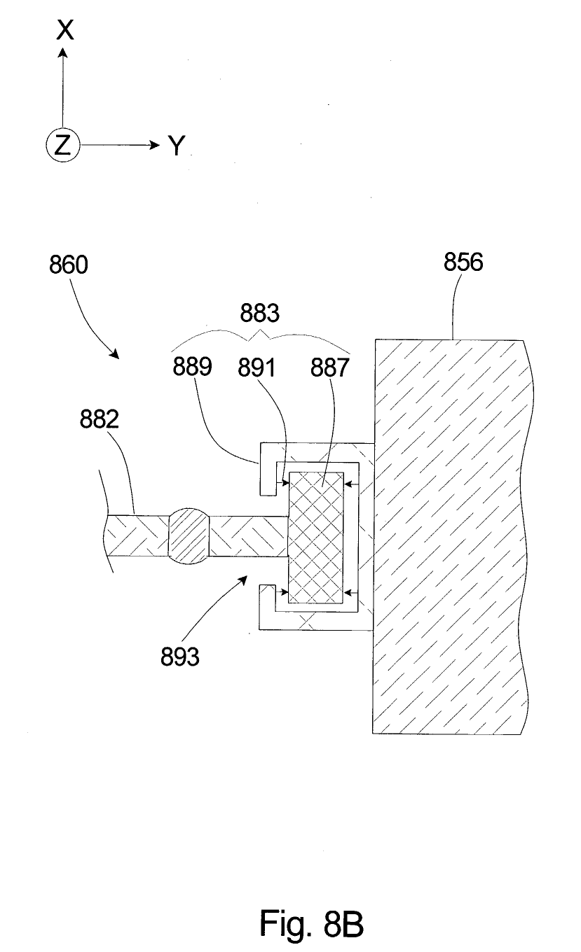

FIG. 8A is a perspective view of still another embodiment of a stage assembly 824 that can be used in the exposure apparatus 10 of FIG. 1 and a mounting base 832. In this embodiment, the stage assembly 824 includes a stage base 802, a stage mover assembly 804, a stage 806 and a control system 826 that are somewhat similar to the corresponding components described above and illustrated in FIGS. 2A-2D. However, in this embodiment, the reaction frame assembly 830 is slightly different.

More specifically, in this embodiment, the reaction frame assembly 830 includes a first reaction mass assembly 850 and a second reaction mass assembly 852 that cooperate to reduce the influence of the reaction forces along the X axis, along the Y axis and about the Z axis. The first reaction mass assembly 850 includes a first X frame 854A, a spaced apart and substantially parallel second X frame 854B, a first mass assembly 856, a first mass support assembly 858, and a first trim mover assembly 862 that are somewhat similar to the corresponding components described above and illustrated in FIGS. 2A-2D. Somewhat similarly, the second reaction mass assembly 852 includes a Y frame 864, a second mass assembly 866, a second mass support assembly 868, and a second trim mover assembly 872 that are somewhat similar to the corresponding components described above and illustrated in FIGS. 2A-2D. However, in this embodiment, the first reaction mass assembly 850 includes a first mass connector assembly 860, and the second reaction mass assembly 850 includes a second mass connector assembly 870 are slightly different than the corresponding components described above.

In FIG. 8A, the first mass connector assembly 860 mechanically connects and couples the X frames 854A, 854B to the first mass assembly 856 and the second mass connector assembly 870 mechanically connects and couples the Y frame 864 to the second mass assembly 866. In FIG. 8A, (i) the first mass connector assembly 860 allows for relative motion along the Z axis, along the Y axis, about the X axis, about the Y axis, and about the Z axis and inhibits relative motion along the X axis between the X frames 854A, 854B and the first mass assembly 856 and (ii) the second mass connector assembly 870 allows for relative motion along the Z axis, along the X axis, about the X axis, about the Y axis, and about the Z axis and inhibits relative motion along the Y axis between the Y frame 864 and the second mass assembly 866. In FIG. 8A, each mass connector assembly 860, 870, includes a pair of spaced apart connectors 882 and a slider connector assembly 883. In one embodiment, each connector 882 is a flexure that is relatively stiff along one degree of freedom and relatively flexible with five degrees of freedom. In this embodiment, each flexure includes a link and a pair of spaced apart flexible joints that allow for motion with five degrees of freedom. Alternatively, each connector assembly 860, 870 can include more than two or less than two connectors 882. Still alternatively, for example, each connector 882 can utilize electromagnetic means, or each connector 882 can be a solid rod.

FIG. 8B illustrates a cross-sectional view taken on line 8B-8B of FIG. 8A. More specifically, FIG. 8B illustrates a portion of one the connectors 882, a portion of the slider connector assembly 883 and a portion of the first mass assembly 856. In this embodiment, the first slider connector 883 includes (i) a slider 887, (ii) a slider guide 889 that receives the slider 887, and (iii) a bearing assembly 891 (illustrated as arrows) that allows the slider 887 to slide along the slider guide 889 along the Z axis but inhibits motion of the slider 887 relative to the slider guide 889 along the X axis and about the X, Y, and Z axes. In FIG. 8B, (i) the slider 887 is generally rectangular shaped and is secured to the end of the connector 882, (ii) the slider guide 889 is somewhat rectangular tube shaped with a rectangular shaped slot 893 for receiving the connector 882 and is secured to the first mass assembly 856, and (iii) the bearing assembly 891 is a pair of opposed fluid bearings. Alternatively, for example, the slider 887 could be secured to the first mass assembly 856, the slider guide 889 could be secured to the connector 882, and/or the bearing assembly 891 can include a rolling type bearing.

With this design, it may not be necessary to adjust the position of the mass assemblies 856, 866 along the Z axis to correspond to the position of the stage base 802. This can simplify the design of the support assemblies 858, 868.

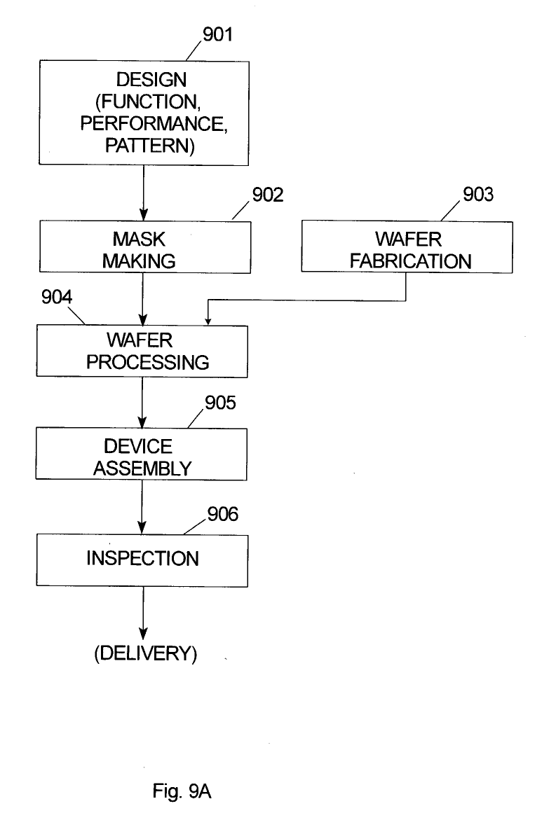

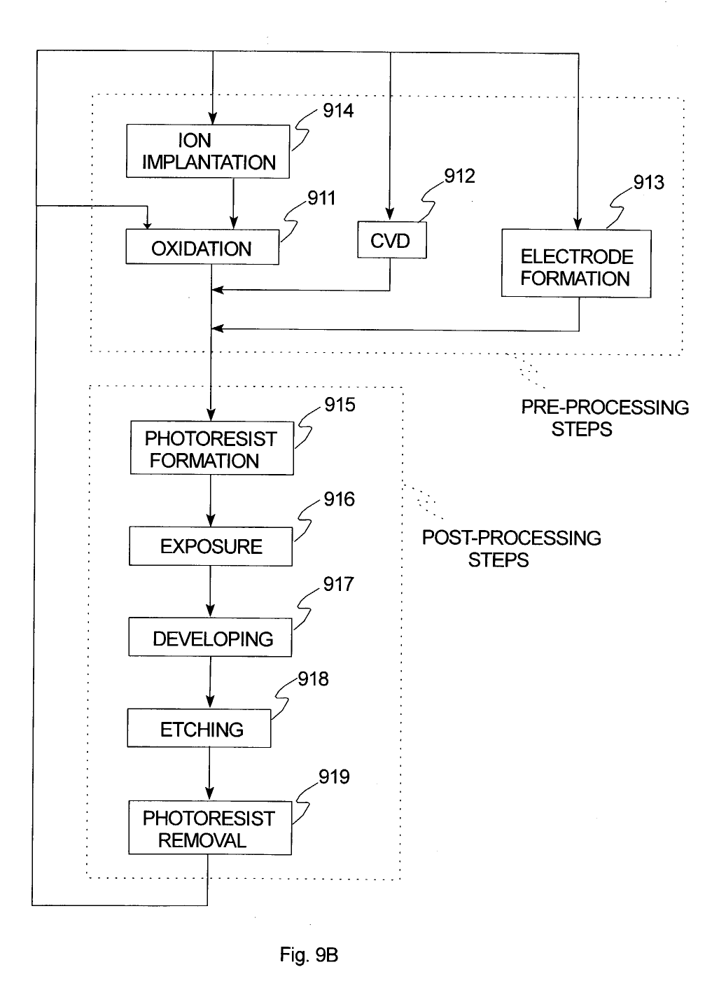

Semiconductor devices can be fabricated using the above described systems, by the process shown generally in FIG. 9A. In step 901, the device's function and performance characteristics are designed. Next, in step 902, a mask (reticle) having a pattern is designed according to the previous designing step, and in a parallel step 903, a wafer is made from a silicon material. The mask pattern designed in step 902 is exposed onto the wafer from step 903 in step 904 by a photolithography system described hereinabove in accordance with the present invention. In step 905, the semiconductor device is assembled (including the dicing process, bonding process and packaging process), finally, the device is then inspected in step 606.

FIG. 9B illustrates a detailed flowchart example of the above-mentioned step 904 in the case of fabricating semiconductor devices. In FIG. 9B, in step 911 (oxidation step), the wafer surface is oxidized. In step 912 (CVD step), an insulation film is formed on the wafer surface. In step 913 (electrode formation step), electrodes are formed on the wafer by vapor deposition. In step 914 (ion implantation step), ions are implanted in the wafer. The above mentioned steps 911 914 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 915 (photoresist formation step), photoresist is applied to a wafer. Next, in step 916 (exposure step), the above-mentioned exposure device is used to transfer the circuit pattern of a mask (reticle) to a wafer. Then, in step 917 (developing step), the exposed wafer is developed, and in step 918 (etching step), parts other than residual photoresist (exposed material surface) are removed by etching. In step 919 (photoresist removal step), unnecessary photoresist remaining after etching is removed. Multiple circuit patterns are formed by repetition of these preprocessing and post-processing steps.

While the particular stage assembly and exposure apparatus as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A stage assembly that moves a device relative to a mounting base along a first axis that is orthogonal to a second axis and a third axis, the stage assembly comprising:
a stage base that supports the stage;
a stage that retains the device;
a stage mover assembly that moves the stage along the first axis and generates reaction forces along the first axis; and
a reaction frame assembly that reduces the magnitude of the reaction forces along the first axis that are transferred to the stage base and the mounting base, the reaction frame assembly including (i) a first mass assembly coupled to the stage mover assembly, and (ii) a first mass support assembly that supports the first mass assembly relative to the mounting base and allows the first mass assembly to move relative to the mounting base along the first axis, the first mass support assembly including a first mass adjuster that adjusts the position of the first mass assembly relative to the mounting base along the third axis.

2. The stage assembly of claim 1 wherein the stage mover assembly generates reaction torque about the third axis, and the reaction frame assembly reduces the magnitude of the reaction torque about the third axis that are transferred to the stage base and the mounting base.

3. The stage assembly of claim 2 wherein the stage mover assembly generates reaction forces along the second axis, and the reaction frame assembly reduces the magnitude of the reaction forces along the second axis that are transferred to the stage base and the mounting base.

4. The stage assembly of claim 3 wherein the reaction frame assembly includes (i) a second mass assembly coupled to the stage mover assembly, and (ii) a second mass support assembly that supports the second mass assembly relative to the mounting base and allows the second mass assembly to move relative to the mounting base along the second axis, and the second mass support assembly includes a second mass adjuster that adjusts the position of the second mass assembly relative to the mounting base along the third axis.

5. The stage assembly of claim 1 wherein the stage mover assembly generates reaction forces along the second axis, and the reaction frame assembly reduces the magnitude of the reaction forces along the second axis that are transferred to the stage base and the mounting base.

6. The stage assembly of claim 5 wherein the reaction frame assembly includes (i) a second mass assembly coupled to the stage mover assembly, and (ii) a second mass support assembly that supports the second mass assembly relative to the mounting base and allows the second mass assembly to move relative to the mounting base along the second axis, and the second mass support assembly includes a second mass adjuster that adjusts the position of the second mass assembly relative to the mounting base along the third axis.

7. The stage assembly of claim 6 wherein the stage mover assembly includes a base adjuster that supports the stage base relative to the mounting base and adjusts the position of the stage base relative to the mounting base.

8. The stage assembly of claim 6 wherein the second mass assembly includes a first Y mass.

9. The stage assembly of claim 8 wherein the first mass assembly includes a first X mass.

10. The stage assembly of claim 9 wherein the first mass assembly includes a second X mass that is spaced apart from the first X mass.

11. The stage assembly of claim 8 wherein the second mass assembly includes a second Y mass that is spaced apart from the first Y mass.

12. The stage assembly of claim 11 wherein the first mass assembly includes a first X mass.

13. The stage assembly of claim 12 wherein the first mass assembly includes a second X mass that is spaced apart from the first X mass.

14. The stage assembly of claim 6 wherein the reaction frame assembly includes a second trim mover assembly that adjusts the position of the second reaction mass assembly along the second axis.

15. The stage assembly of claim 14 wherein the reaction frame assembly includes a first trim mover assembly that adjusts the position of the first mass assembly along the first axis.

16. The stage assembly of claim 6 wherein the stage mover assembly generates a reaction torque about the third axis and the second mass assembly includes a torque reducer that generates a correction torque that counteracts the reaction torque.

17. The stage assembly of claim 1 wherein the reaction frame assembly includes a first trim mover assembly that adjusts the position of the first mass assembly along the first axis.

18. The stage assembly of claim 1 wherein the stage mover assembly generates a reaction torque about the third axis and the first mass assembly includes a torque reducer that generates a correction torque that counteracts the reaction torque.

19. The stage assembly of claim 1 wherein the reaction frame assembly includes a first mass connector assembly that connects the stage mover assembly to the first mass assembly and allows the first mass assembly to move along the third axis relative to the first mass assembly.

20. An exposure apparatus including the stage assembly of claim 1.

21. A device manufactured with the exposure apparatus according to claim 20.

22. A wafer on which an image has been formed by the exposure apparatus of claim 20.

23. A stage assembly that moves a device relative to a mounting base along a first axis that is orthogonal to a second axis and a third axis, the stage assembly comprising:
a stage base that supports the stage;
a stage that retains the device;
a stage mover assembly that moves the stage along the first axis and the second axis and generates reaction forces along the first axis and the second axis; and
a reaction frame assembly that reduces the magnitude of the reaction forces along the first axis and along the second axis that are transferred to the stage base, the reaction frame assembly including (i) a first mass assembly coupled to the stage mover assembly, and (ii) a first mass support assembly that supports the first mass assembly and allows the first reaction mass assembly to move relative to the mounting base and the stage base.

24. The stage assembly of claim 23 wherein the first mass support assembly includes a first mass adjuster that adjusts the position of the first mass assembly relative to the mounting base along the third axis.

25. The stage assembly of claim 23 wherein the stage mover assembly generates reaction torque about the third axis, and the reaction frame assembly reduces the magnitude of the reaction torque about the third axis that are transferred to the stage base.

26. The stage assembly of claim 23 wherein the reaction frame assembly includes (i) a second mass assembly coupled to the stage mover assembly, and (ii) a second mass support assembly that supports the second mass assembly and allows the second mass assembly to move relative to the mounting base and the stage base.

27. The stage assembly of claim 26 wherein the first mass support assembly includes a first mass adjuster that adjusts the position of the first mass assembly relative to the mounting base along the third axis.

28. The stage assembly of claim 26 wherein the second mass support assembly includes a second mass adjuster that adjusts the position of the second mass assembly relative to the mounting base along the third axis.

29. The stage assembly of claim 28 wherein the stage mover assembly includes a base adjuster that supports the stage base relative to the mounting base and adjusts the position of the stage base relative to the mounting base.

30. The stage assembly of claim 28 wherein the second mass assembly includes a first Y mass.

31. The stage assembly of claim 30 wherein the first mass assembly includes a first X mass.

32. The stage assembly of claim 31 wherein the first mass assembly includes a second X mass that is spaced apart from the first X mass.

33. The stage assembly of claim 30 wherein the second mass assembly includes a second Y mass that is spaced apart from the first Y mass.

34. The stage assembly of claim 33 wherein the first mass assembly includes a first X mass.

35. The stage assembly of claim 34 wherein the first mass assembly includes a second X mass that is spaced apart from the first X mass.

36. The stage assembly of claim 23 wherein the reaction frame assembly includes a first trim mover assembly that adjusts the position of the first mass assembly along the first axis.

37. The stage assembly of claim 23 wherein the stage mover assembly generates a reaction torque about the third axis and the first mass assembly includes a torque reducer that generates a correction torque that counteracts the reaction torque.

38. The stage assembly of claim 23 wherein the reaction frame assembly includes a first mass connector assembly that connects the stage mover assembly to the first mass assembly and allows the first mass assembly to move along the third axis relative to the stage.

39. An exposure apparatus including the stage assembly of claim 23.

40. A device manufactured with the exposure apparatus according to claim 39.

41. A wafer on which an image has been formed by the exposure apparatus of claim 39.

42. A method for making a stage assembly that moves a device relative to a mounting base along a first axis that is orthogonal to a second axis and a third axis, the method comprising the steps of:
providing a stage base;
retaining the device with a stage that is supported by the stage base;
moving the stage with a stage mover assembly along the first axis and generating reaction forces along the first axis; and
reducing the magnitude of the reaction forces along the first axis that are transferred to the stage base with a reaction frame assembly, the reaction frame assembly including (i) a first mass assembly coupled to the stage mover assembly, and (ii) a first mass support that supports the first mass assembly relative to the mounting base and allows the first mass assembly to move relative to the mounting base along the first axis, the first mass support assembly including a first mass adjuster that adjusts the position of the first mass assembly relative to the mounting base along the third axis.

43. The method of claim 42 wherein the step of reducing includes reducing the magnitude of the reaction torque about the third axis that are transferred to the stage base.

44. The method of claim 43 wherein the step of moving the stage includes moving the stage along the second axis and generating reaction forces along the second axis, and wherein the step of reducing includes reducing the magnitude of the reaction forces along the second axis that are transferred to the stage base.

45. The method of claim 44 wherein the step of reducing includes the steps of (i) coupling a second mass assembly to the stage mover assembly, and (ii) supporting the second mass assembly with a second mass support assembly relative to the mounting base, the second mass support assembly allowing the second mass assembly to move relative to the mounting base along the second axis, and the second mass support assembly includes a second mass adjuster that adjusts the position of the second reaction mass assembly relative to the mounting base along the third axis.

46. The method of claim 42 wherein the step of moving includes the step of moving the stage along the second axis and generating reaction forces along the second axis, and wherein the step of reducing includes the step of reducing the magnitude of the reaction forces along the second axis that are transferred to the stage base.

47. The method of claim 46 wherein the step of reducing includes (i) coupling a second mass assembly to the stage mover assembly, and (ii) supporting the second mass assembly relative to the mounting base with a second mass support assembly, the second mass support assembly allowing the second mass assembly to move relative to the mounting base along the second axis, and the second mass support assembly includes a second mass adjuster that adjusts the position of the second mass assembly relative to the mounting base along the third axis.

48. The method of claim 47 further comprising the step of adjusting the position of the stage base relative to the mounting base with a base adjuster.

49. The method of claim 47 further comprising the step of adjusting the position of the second reaction mass assembly along the second axis with a second trim mover assembly.

50. The method of claim 47 wherein the stage mover assembly generates a reaction torque about the third axis and the second mass assembly includes a torque reducer that generates a correction torque that counteracts the reaction torque.

51. The method of claim 50 further comprising the step of adjusting the position of the first reaction mass assembly along the first axis with a first trim mover assembly.

52. The method of claim 42 further comprising the step of adjusting the position of the stage base relative to the mounting base and the first mass assembly.

53. The method of claim 42 further comprising the step of adjusting the position of the first reaction mass assembly along the first axis with a first trim mover assembly.

54. The method of claim 42 wherein the stage mover assembly generates a reaction torque about the third axis and the first mass assembly includes a torque reducer that generates a correction torque that counteracts the reaction torque.

55. The method of claim 42 further comprising the step of connecting the stage mover assembly to the first mass assembly with a first mass connector assembly, the first mass connector assembly allowing relative movement between the first mass assembly and the stage base along the third axis.

56. A method for making an exposure apparatus that forms an image on a wafer, the method comprising the steps of:
providing an irradiation apparatus that irradiates the wafer with radiation to form the image on the wafer; and
providing the stage assembly made by the method of claim 42.

57. A method of making a wafer utilizing the exposure apparatus made by the method of claim 56.

58. A method of making a device including at least the exposure process:
wherein the exposure process utilizes the exposure apparatus made by the method of claim 56.

59. A method for making a stage assembly that moves a device relative to a mounting base along a first axis that is orthogonal to a second axis and a third axis, the method comprising the steps of:
providing a stage base;
retaining the device with a stage that is positioned above the stage base;
moving the stage with a stage mover assembly along the first axis and along the second axis and generating reaction forces along the first axis and the second axis; and
reducing the magnitude of the reaction forces along the first axis and the second axis that are transferred to the stage base with a reaction frame assembly, the reaction frame assembly including (i) a first mass assembly coupled to the stage mover assembly, and (ii) a first mass support that supports the first mass assembly relative to the mounting base and allows the first mass assembly to move relative to the mounting base.

60. The method of claim 59 wherein the step of moving the stage includes generating reaction torque about the third axis, and wherein the step of reducing includes reducing the magnitude of the reaction torque about the third axis that are transferred to the stage base.

61. The method of claim 59 further comprising the step of adjusting the position of the first mass assembly relative to the mounting base along the third axis.

62. The method of claim 59 wherein the step of reducing the magnitude includes the steps of (i) coupling a second mass assembly to the stage mover assembly, and (ii) supporting the second mass assembly with a second mass support assembly relative to the mounting base, the second mass support assembly allowing the second mass assembly to move relative to the mounting base and adjusting the position of the second reaction mass assembly relative to the mounting base along the third axis.

63. The method of claim 59 further comprising the step of adjusting the position of the stage base relative to the mounting base along the third axis with a base adjuster.

64. The method of claim 59 further comprising the step of adjusting the position of the first reaction mass assembly along the first axis with a first trim mover assembly.

65. The method of claim 59 wherein the stage mover assembly generates a reaction torque about the third axis and the first mass assembly includes a torque reducer that generates a correction force that counteracts the reaction force.

66. The method of claim 59 further comprising the step of connecting the stage mover assembly to the first mass assembly with a first mass connector assembly, the first mass connector assembly allowing relative movement between the first mass assembly and the stage base along the third axis.

67. A method for making an exposure apparatus that forms an image on a wafer, the method comprising the steps of:
providing an irradiation apparatus that irradiates the wafer with radiation to form the image on the wafer; and
providing the stage assembly made by the method of claim 59.

68. A method of making a wafer utilizing the exposure apparatus made by the method of claim 67.

69. A method of making a device including at least the exposure process:
wherein the exposure process utilizes the exposure apparatus made by the method of claim 67.
